(19) United States
(12) Patent Application Publication
(10) Pub. No.: US 2013/0295496 A1
(43) Pub. Date: Nov. 7, 2013

(54) ELECTROPHOTOGRAPHIC PHOTOCONDUCTOR, AND IMAGE FORMING METHOD, IMAGE FORMING APPARATUS, AND PROCESS CARTRIDGE USING THE ELECTROPHOTOGRAPHIC PHOTOCONDUCTOR

(71) Applicants: Yuuji Tanaka, Shizuoka (JP); Kazukiyo Nagai, Shizuoka (JP); Tetsuro Suzuki, Shizuoka (JP); Yuusuke Koizuka, Shizuoka (JP)

(72) Inventors: Yuuji Tanaka, Shizuoka (JP); Kazukiyo Nagai, Shizuoka (JP); Tetsuro Suzuki, Shizuoka (JP); Yuusuke Koizuka, Shizuoka (JP)

(21) Appl. No.: 13/980,401

(22) PCT Filed: Jan. 12, 2012
(86) PCT No.: PCT/JP12/51013

§ 371 Date: Jul. 18, 2013

(30) Foreign Application Priority Data
Jan. 21, 2011 (JP) 2011-010766

(51) Int. Cl. G03G 15/00

(52) U.S. Cl. CPC G03G 5/07
USPC 430/56; 399/159

(57) ABSTRACT

An electrophotographic photoconductor including: a conductive substrate; and at least a photoconductive layer on the conductive substrate, wherein an uppermost surface layer of the photoconductive layer includes a three-dimensionally crosslinked film formed through polymerization among compounds each containing a charge transporting compound and three or more [(tetrahydro-2H-pyran-2-yl)oxy]methyl groups where the charge transporting compound has one or more aromatic rings and the [(tetrahydro-2H-pyran-2-yl)oxy]methyl groups are bound to the aromatic rings of the charge transporting compound, wherein the polymerization starts after some of the [(tetrahydro-2H-pyran-2-yl)oxy]methyl groups have been partially cleaved and eliminated, and wherein the three-dimensionally cross-linked film has an ionization potential of 5.4 or higher.

### TECHNICAL FIELD

The present invention relates to an electrophotographic photoconductor (hereinafter may be referred to as “photoconductor,” “latent electrostatic image bearing member” or “image bearing member”) having remarkably high abrasion resistance to repetitive use and having such high durability that can continue to form high-quality images with less image defects for a long period of time; and an image forming method, an image forming apparatus and a process cartridge each using the electrophotographic photoconductor.

### BACKGROUND ART

By virtue of their various advantageous properties, organic photoconductors (OPCs) have recently been used in a lot of copiers, facsimiles, laser printers and complex machines thereof, in place of inorganic photoconductors. The reason for this includes: (1) optical characteristics such as wide light absorption wavelength range and large light absorption amount; (2) electrical characteristics such as high sensitivity and stable chargeability; (3) a wide range of materials usable; (4) easiness in production; (5) low cost; and (6) non-toxicity.

Also, in an attempt to downsize image forming apparatuses, photoconductors have recently been downsized more and more. In addition, to make the image forming apparatuses operate at higher speed and free of maintenance, keen demand has arisen for photoconductors having high durability. From this viewpoint, the organic photoconductors have a charge transport layer mainly containing a low-molecular-weight charge transporting compound and an inert polymer and thus are soft in general. When repetitively used in the electrophotographic process, the organic photoconductors disadvantageously tend to involve abrasion due to mechanical load given by the developing system or cleaning system.

Moreover, toner particles have had smaller and smaller particle diameters to meet the requirement of high-quality image formation. To improve cleanability of such small toner particles, the hardness of the rubber of a cleaning blade must be increased and also the contact pressure between the cleaning blade and the photoconductor must be increased. This is another cause of accelerating abrasion of the photoconductor. Such abrasion of the photoconductor degrades sensitivity and electrical characteristics such as chargeability, causing a drop in image density and forming abnormal images such as background smear. Also, locally abraded scratches lead to cleaning failures to form images with streaks of stain.

Under such circumstances, various improvements have been made for the purpose of improving the organic photoconductors in abrasion resistance. For example, the following photoconductors have been proposed: an organic photoconductor having a charge transport layer containing a curable binder (see PTL 1); an organic photoconductor containing a polymeric charge transport compound (see PTL 2); an organic photoconductor having a charge transport layer containing inorganic filler dispersed therein (see PTL 3); an organic photoconductor containing a cured product of polyfunctional acrylate monomers (see PTL 4); an organic photoconductor having a charge transport layer formed using a coating liquid containing a monomer having a carbon-carbon double bond, a charge transport material having a carbon-carbon double bond, and a binder resin (see PTL 5); an organic photoconductor containing a cured compound of a hole transporting compound having two or more chain polymerizable functional groups in one molecule thereof (see PTL 6); an organic photoconductor formed using a colloidal silica-containing curable silicone resin (see PTL 7); an organic photoconductor having a resin layer where an organic silicon-modified hole transporting compound is bound to a curable organic silicon-based polymer (see PTLs 8 and 9); an organic photoconductor in which a curable siloxane resin having a charge transporting property-imparting group is cured so as to form a three-dimensional network structure (see PTL 10); an organic photoconductor containing fine conductive particles and a resin three-dimensionally crosslinked with a charge transporting compound having at least one hydroxyl group (see PTL 11); an organic photoconductor containing a crosslinked resin formed by crosslinking an aromatic isocyanate compound with a polyol having at least a reactive charge transporting compound and two or more hydroxyl groups (see PTL 12); an organic photoconductor containing a melamine formaldehyde resin three-dimensionally crosslinked with a charge transporting compound having at least one hydroxyl group (see PTL 13); and an organic photoconductor containing a resol-type phenol resin crosslinked with a charge transporting compound having a hydroxyl group (see PTL 14).

Furthermore, the following organic photoconductors have been proposed: an organic photoconductor containing a photofunctional organic compound able to form a curable film, sulfonic acid and/or derivatives thereof, and an amine having a boiling point of 250° C. or lower (see PTL 15); and an organic photoconductor containing a crosslinked product formed using a coating liquid containing at least one selected from guanamine compounds and melamine compounds and at least one kind of charge transporting material having at least one substituent selected from —OH, —OCH₃, —NH₂, —SH and —COOH, wherein the solid content concentration of the at least one selected from guanamine compounds and melamine compounds in the coating liquid is 0.1% by mass to 5% by mass, and the solid content concentration of the at least one kind of charge transporting material in the coating liquid is 90% by mass or more (see PTL 16).

As seen in these conventional arts, the three-dimensionally crosslinked surface layer is excellent in mechanical durability and thus can considerably prevent the service life of the photoconductor from being shortened due to abrasion. However, the three-dimensionally crosslinked film of the electrophotographic photoconductor described in PTL 6 is a three-dimensionally crosslinked film formed through radical polymerization using ultraviolet rays or electron rays, and proceeding radical polymerization reaction requires large-scale production apparatuses such as an apparatus for controlling the oxygen level, an apparatus for applying ultraviolet rays, and an apparatus for applying electron rays. Also, the techniques described in PTLs 13 to 16 can form a three-dimensionally crosslinked film through heating. These techniques are advantageous in productivity, and the formed organic photoconductors are excellent in abrasion resistance. However, the technique described in PTL 12 forms a cured product via urethane bonds, which is poor in charge transporting property and is difficult to practically use in terms of electrical characteristics. The techniques described in PTLs 13 to 16 form a surface layer formed by three-dimensionally crosslinking a charge transporting compound having a high polar group (e.g., a hydroxyl group) with a reactive resin such as a melamine resin or a phenol resin, and the surface layer is relatively excellent in electrical characteristics.

The surface layer of the electrophotographic photoconductor disclosed in PTL 15 is a cured film obtained by curing photofunctional organic compounds in the presence of sulfonic acid and/or derivatives thereof. This cured film is a good cured film which can stably be formed since the curing reaction successfully proceeds to thereby reduce the residual amount of hydrolysable groups (e.g., a hydroxyl group) to a satisfactory extent. However, it is difficult to completely eliminate such reactive groups (e.g., a hydrolysable group) from the cured film. This is because the crosslinking reaction gradually reduces molecular mobility in the film during the process of curing. As a result, there inevitably are unreacted reactive groups left. When polar groups such as a hydroxyl group are left in the unreacted state, the formed photoconductor is easier to decrease in chargeability. In addition, it is easier to form images with low image density when exposed to oxidative gas (NOx) generated under high-temperature, high-humidity environment or generated by charged groups. When electrophotographic photoconductors having quite high abrasion resistance are used for a long period of time, the residual reactive groups are easier to impair the properties or stability of the cured film.

The electrophotographic photoconductor described in PTL 16 uses a charge transporting compound at a concentration as high as 90% or more, and thus is excellent in charge transporting property and exhibits good electrical characteristics. However, the problems raised by the residual hydroxyl groups are the same as in PTL 15.

In view of this, there has been proposed a technique of forming a cured film from a reactive resin such as a melamin resin or a guanamine resin and a charge transporting compound in which the hydroxyl group and the like have been blocked (see PTL 17). Although this technique can prevent the high polar groups from remaining, the blocked hydroxyl group ununiformly reacts with the reactive resin, making it possible to form a three-dimensionally crosslinked film excellent in mechanical strength. Also, use of a charge transporting compound having four reactive groups whose hydroxyl groups have been blocked can increase mechanical strength. However, the disclosed charge transporting compound where two triphenylamine structures are covalently bonded together has the following problems. Specifically, while π-electron cloud can spread in the two triphenylamine structures covalently bonded together to lead to excellent charge transporting property, the formed charge transporting compound tends to have low oxidation potential. After long-term use, it easily decreases in chargeability and also, image density is easily decreases.

As described above, there could not be provided a highly durable photoconductor which is excellent in mechanical strength, electrical characteristics (i.e., chargeability, charge transporting property and residual potential property), environmental independency, gas resistance and productivity, which has truly long service life, and which can stably form images.

### CITATION LIST

### Patent Literature

PTL 1: Japanese Patent Application Laid-Open (JP-A) No. 56-048637
PTL 2: JP-A No. 64-001728
PTL 3: JP-A No. 04-281461
PTL 4: Japanese Patent (JP-B) No. 3262488
PTL 5: JP-B No. 3194392
PTL 6: JP-A No. 2000-66425
PTL 7: JP-A No. 06-118681
PTL 8: JP-A No. 09-124943
PTL 9: JP-A No. 09-190004
PTL 10: JP-A No. 2000-171990
PTL 11: JP-A No. 2003-186223
PTL 12: JP-A No. 2007-293197
PTL 13: JP-A No. 2008-299327
PTL 14: JP-B No. 4262061
PTL 15: JP-A No. 2006-251771
PTL 16: JP-A No. 2009-229549
PTL 17: JP-A No. 2006-084711

### SUMMARY OF INVENTION

### Technical Problem

An electrophotographic photoconductor able to stably output high-quality images for a long period of time is required to meet all of the following over time: excellent mechanical durability (e.g., abrasion resistance and scratch resistance), excellent electrical characteristics (e.g., stable chargeability, stable sensitivity and residual potential property), excellent environmental stability (especially under high-temperature, high-humidity conditions) and excellent gas resistance (e.g., NOx resistance).

The present invention has been made in view of the above circumstances, and aims to solve the above-described existing problems and achieve the following objects. Specifically, an object of the present invention is to provide: a highly durable electrophotographic photoconductor which, even after repetitive use, exhibits excellent mechanical durability (e.g., abrasion resistance and scratch resistance), excellent electrical characteristics (e.g., stable chargeability, stable sensitivity and residual potential property), excellent environmental stability (especially under high-temperature, high-humidity conditions) and excellent gas resistance (e.g., NOx resistance) and can continue to perform high-quality image formation with less image defects for a long period of time; and an image forming method, an image forming apparatus and a process cartridge each using the electrophotographic photoconductor.

### Solution to Problem

The present inventors conducted extensive studies to solve the above-described problems, and have found that these problems can be solved by using the uppermost surface layer of a photoconductive layer, the uppermost surface layer including a three-dimensionally crosslinked film which has an ionization potential of 5.4 or higher and which is formed through polymerization reaction among highly reactive compounds each containing a charge transporting compound and three or more [(tetrahydro-2H-pyran-2-yl)oxy]methyl groups where the charge transporting compound has one or more aromatic rings and the [(tetrahydro-2H-pyran-2-yl)oxy]methyl groups are bound to the aromatic rings of the charge transporting compound.

<1> An electrophotographic photoconductor including:

a conductive substrate; and

at least a photoconductive layer on the conductive substrate,

wherein an uppermost surface layer of the photoconductive layer includes a three-dimensionally crosslinked film formed through polymerization among compounds each containing a charge transporting compound and three or more [(tetrahydro-2H-pyran-2-yl)oxy]methyl groups where the charge transporting compound has one or more aromatic rings and the [(tetrahydro-2H-pyran-2-yl)oxy]methyl groups are bound to the aromatic rings of the charge transporting compound,

wherein the polymerization starts after some of the [(tetrahydro-2H-pyran-2-yl)oxy]methyl groups have been partially cleaved and eliminated, and

wherein the three-dimensionally crosslinked film has an ionization potential of 5.4 or higher.

<2> The electrophotographic photoconductor according to <1>, wherein the three-dimensionally crosslinked film is insoluble to tetrahydrofuran.

<3> The electrophotographic photoconductor according to <1> or <2>, wherein the compound containing a charge transporting compound and three or more [(tetrahydro-2H-pyran-2-yl)oxy]methyl groups where the charge transporting compound has one or more aromatic rings and the [(tetrahydro-2H-pyran-2-yl)oxy]methyl groups are bound to the aromatic rings of the charge transporting compound is a compound represented by the following General Formula (1):

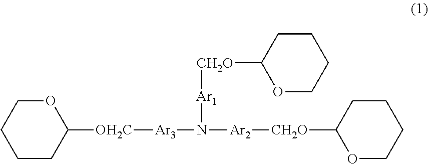

where Ar₁, Ar₂ and Ar₃ each denote a divalent group of a C6-C12 aromatic hydrocarbon which may have an alkyl group as a substituent.

<4> The electrophotographic photoconductor according to <1> or <2>, wherein the compound containing a charge transporting compound and three or more [(tetrahydro-2H-pyran-2-yl)oxy]methyl groups where the charge transporting compound has one or more aromatic rings and the [(tetrahydro-2H-pyran-2-yl)oxy]methyl groups are bound to the aromatic rings of the charge transporting compound is a compound represented by the following General Formula (2):

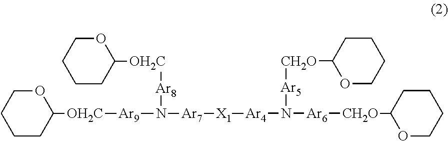

wherein X₁ denotes a C1-C4 alkylene group, a C2-C6 alkylidene group, a divalent group formed of two C2-C6 alkylidene groups bonded together via a phenylene group, or an oxygen atom, and Ar₄, Ar₅, Ar₆, Ar₇, Ar₈ and Ar₉ each denote a divalent group of a C6-C12 aromatic hydrocarbon which may have an alkyl group as a substituent.

<5> The electrophotographic photoconductor according to <3>, wherein the compound containing a charge transporting compound and three or more [(tetrahydro-2H-pyran-2-yl)oxy]methyl groups where the charge transporting compound has one or more aromatic rings and the [(tetrahydro-2H-pyran-2-yl)oxy]methyl groups are bound to the aromatic rings of the charge transporting compound is a compound represented by the following General Formula (3):

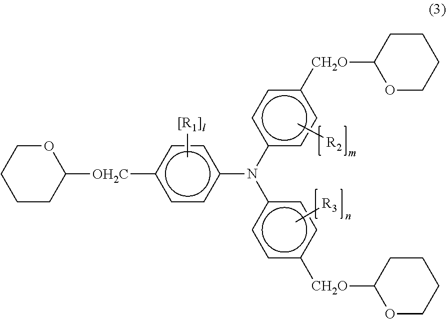

wherein R₁, R₂ and R₃, which may be the same or different, each denote a hydrogen atom, a methyl group or an ethyl group; and l, n and m each denote an integer of 1 to 4.

<6> The electrophotographic photoconductor according to <4>, wherein the compound containing a charge transporting compound and three or more [(tetrahydro-2H-pyran-2-yl)oxy]methyl groups where the charge transporting compound has one or more aromatic rings and the [(tetrahydro-2H-pyran-2-yl)oxy]methyl groups are bound to the aromatic rings of the charge transporting compound is a compound represented by the following General Formula (4):

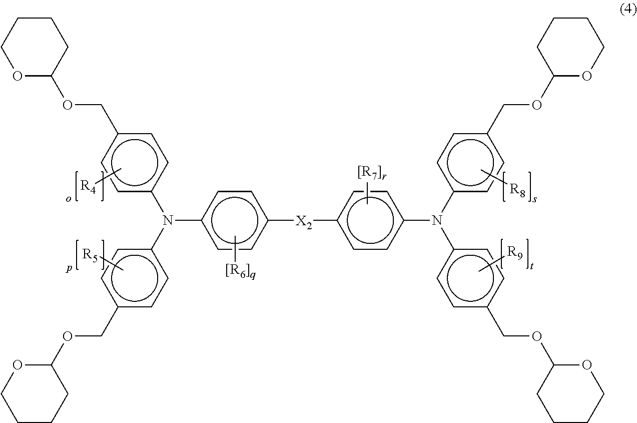

where X₂ denotes —CH₂—, —CH₂CH₂—, —C(CH₃)₂-Ph-C(CH₃)₂—, —C(CH₂)₅— or —O—; R₄, R₅, R₆, R₇, R₈ and R₉, which may be the same or different, each denote a hydrogen atom, a methyl group or an ethyl group; and o, p, q, r, s and t each denote an integer of 1 to 4.

<7> The electrophotographic photoconductor according to any one of <1> to <6>, wherein the photoconductive layer contains a charge generation layer, a charge transport layer and a crosslinked charge transport layer disposed in this order on the conductive substrate, and the crosslinked charge transport layer is the three-dimensionally crosslinked film.

<8> An image forming method including:

charging a surface of an electrophotographic photoconductor;

exposing the charged surface of the electrophotographic photoconductor to light to form a latent electrostatic image;

developing the latent electrostatic image with a toner to form a visible image;

transferring the visible image onto a recording medium; and

fixing the transferred visible image on the recording medium,

wherein the electrophotographic photoconductor is the electrophotographic photoconductor according to any one of <1> to <7>.

<9> The image forming method according to <8>, wherein the latent electrostatic image is digitally written on the electrophotographic photoconductor in the exposing.

<10> An image forming apparatus including:

an electrophotographic photoconductor;

a charging unit configured to charge a surface of the electrophotographic photoconductor;

an exposing unit configured to expose the charged surface of the electrophotographic photoconductor to light to form a latent electrostatic image;

a developing unit configured to develop the latent electrostatic image with a toner to form a visible image;

a transfer unit configured to transfer the visible image onto a recording medium; and

a fixing unit configured to fix the transferred visible image on the recording medium,

wherein the electrophotographic photoconductor is the electrophotographic photoconductor according to any one of <1> to <7>.

<11> The image forming apparatus according to <10>, wherein the exposing unit digitally writes the latent electrostatic image on the electrophotographic photoconductor.

<12> A process cartridge including:

an electrophotographic photoconductor; and

at least one unit selected from the group consisting of a charging unit, an exposing unit, a developing unit, a transfer unit, a cleaning unit and a charge-eliminating unit,

wherein the process cartridge is detachably mounted to a main body of an image forming apparatus, and

wherein the electrophotographic photoconductor is the electrophotographic photoconductor according to any one of <1> to <7>.

### Advantageous Effects of Invention

The present invention can provide: a highly durable electrophotographic photoconductor which, even after repetitive use, exhibits excellent mechanical durability (e.g., abrasion resistance and scratch resistance), excellent electrical characteristics (e.g., stable chargeability, stable sensitivity and residual potential property), excellent environmental stability (especially under high-temperature, high-humidity conditions) and excellent gas resistance (e.g., NOx resistance) and can continue to perform high-quality image formation with less image defects for a long period of time; and an image forming method, an image forming apparatus and a process cartridge each using the electrophotographic photoconductor.

### BRIEF DESCRIPTION OF DRAWINGS

FIG. 1 is an infrared absorption spectrum (KBr tablet method) of the compound obtained in Synthesis Example 1, where the horizontal axis indicates wavenumbers (cm⁻¹) and the vertical axis indicates transmittance (%).

FIG. 2 is an infrared absorption spectrum (KBr tablet method) of the compound obtained in Synthesis Example 2, where the horizontal axis indicates wavenumbers (cm⁻¹) and the vertical axis indicates transmittance (%).

FIG. 3 is an infrared absorption spectrum (KBr tablet method) of the compound obtained in Synthesis Example 3, where the horizontal axis indicates wavenumbers (cm⁻¹) and the vertical axis indicates transmittance (%).

FIG. 4 is an infrared absorption spectrum (KBr tablet method) of the compound obtained in Synthesis Example 4, where the horizontal axis indicates wavenumbers (cm⁻¹) and the vertical axis indicates transmittance (%).

FIG. 5 is an infrared absorption spectrum (KBr tablet method) of the compound obtained in Synthesis Example 5, where the horizontal axis indicates wavenumbers (cm⁻¹) and the vertical axis indicates transmittance (%).

FIG. 6 is an infrared absorption spectrum (KBr tablet method) of the compound obtained in Synthesis Example 6, where the horizontal axis indicates wavenumbers (cm⁻¹) and the vertical axis indicates transmittance (%).

FIG. 7 is an infrared absorption spectrum (KBr tablet method) of the compound obtained in Synthesis Example 7, where the horizontal axis indicates wavenumbers (cm⁻¹) and the vertical axis indicates transmittance (%).

FIG. 8 is an infrared absorption spectrum (KBr tablet method) of the compound obtained in Synthesis Example 8, where the horizontal axis indicates wavenumbers (cm⁻¹) and the vertical axis indicates transmittance (%).

FIG. 9 is an infrared absorption spectrum (KBr tablet method) of the compound obtained in Synthesis Example 9, where the horizontal axis indicates wavenumbers (cm⁻¹) and the vertical axis indicates transmittance (%).

FIG. 10 is an infrared absorption spectrum (KBr tablet method) of the compound obtained in Synthesis Example 10, where the horizontal axis indicates wavenumbers (cm⁻¹) and the vertical axis indicates transmittance (%).

FIG. 11 is an infrared absorption spectrum (KBr tablet method) of the compound obtained in Synthesis Example 11, where the horizontal axis indicates wavenumbers (cm⁻¹) and the vertical axis indicates transmittance (%).

FIG. 12 is an infrared absorption spectrum (KBr tablet method) of the compound obtained in Synthesis Example 12, where the horizontal axis indicates wavenumbers (cm⁻¹) and the vertical axis indicates transmittance (%).

FIG. 13 is an infrared absorption spectrum (KBr tablet method) of the compound obtained in Synthesis Example 13, where the horizontal axis indicates wavenumbers (cm⁻¹) and the vertical axis indicates transmittance (%).

FIG. 14 is an infrared absorption spectrum (KBr tablet method) of the compound obtained in Synthesis Example 14, where the horizontal axis indicates wavenumbers (cm⁻¹) and the vertical axis indicates transmittance (%).

FIG. 15 is a schematic view of one exemplary layer structure of the electrophotographic photoconductor of the present invention.

FIG. 16 is a schematic view of another exemplary layer structure of the electrophotographic photoconductor of the present invention.

FIG. 17 is a schematic view of still another exemplary layer structure of the electrophotographic photoconductor of the present invention.

FIG. 18 is a schematic view of yet another exemplary layer structure of the electrophotographic photoconductor of the present invention.

FIG. 19 is a schematic view of even another exemplary layer structure of the electrophotographic photoconductor of the present invention.

FIG. 20 is an explanatory, schematic view of an image forming apparatus and an electrophotographic process of the present invention.

FIG. 21 is an explanatory, schematic view of a tandem full-color image forming apparatus of the present invention.

FIG. 22 is an explanatory, schematic view of one exemplary process cartridge of the present invention.

FIG. 23 is a spectrum measured through photoelectron yield spectroscopy of the three-dimensionally crosslinked film produced in Example 2.

FIG. 24 is a spectrum measured through photoelectron yield spectroscopy of the three-dimensionally crosslinked film produced in Comparative Example 4.

### DESCRIPTION OF EMBODIMENTS

### Electrophotographic Photoconductor

An electrophotographic photoconductor of the present invention contains a conductive substrate and at least a photoconductive layer on the conductive substrate, wherein the uppermost surface layer of the photoconductive layer includes a three-dimensionally crosslinked film formed through polymerization reaction among compounds each containing a charge transporting compound and three or more [(tetrahydro-2H-pyran-2-yl)oxy]methyl groups where the charge transporting compound has one or more aromatic rings and the [(tetrahydro-2H-pyran-2-yl)oxy]methyl groups are bound to the aromatic rings of the charge transporting compound (compounds each containing a charge transporting compound and three or more [(tetrahydro-2H-pyran-2-yl)oxy]methyl groups bound to one or more aromatic rings of the charge transporting compound), and the three-dimensionally crosslinked film has an ionization potential of 5.4 or higher.

Here, the present inventors have found that the compounds each containing a charge transporting compound and three or more [(tetrahydro-2H-pyran-2-yl)oxy]methyl groups bound to one or more aromatic ring of the charge transporting compound react together in the presence of an appropriate catalyst to form a three-dimensionally crosslinked film that is insoluble to, for example, an organic solvent and has a high crosslink density. The present invention is based on this finding. In consideration of the infrared absorption spectra and mass reduction before and after reaction, this reaction was found to be a reaction in which some of the [(tetrahydro-2H-pyran-2-yl)oxy]methyl groups were partially cleaved and eliminated.

The (tetrahydro-2H-pyran-2-yl) group has conventionally been known as a protective group for a hydroxyl group. For example, this fact is described in JP-A No. 2006-084711. Although there have been studied cured products through reaction between compounds having this protective group and reactive species such as melamine, no reports have been presented on formation of a crosslinked film using this protective group alone.

Also, the term “protective group” leads generally to a concept where the protective group is removed to allow a target reaction to proceed. Assuming that the reaction proceeds after the [(tetrahydro-2H-pyran-2-yl)oxy]methyl groups have been changed to methylol groups, the obtained three-dimensionally crosslinked film is the same as a crosslinked film of a methylol compound. As a result of studies, however, it has been found in the present invention that the compound containing a charge transporting compound and three or more [(tetrahydro-2H-pyran-2-yl)oxy]methyl groups bound to one or more aromatic rings thereof react together without the [(tetrahydro-2H-pyran-2-yl)oxy]methyl groups being changed to methylol groups. Thus, the [(tetrahydro-2H-pyran-2-yl)oxy]methyl groups remain as is in unreacted sites. As such, the [(tetrahydro-2H-pyran-2-yl)oxy]methyl groups remaining in the structure of the crosslinked film influence properties of the film. The three-dimensionally crosslinked film of the present invention has an advantages that it is smaller than a crosslinked cured product of a methylol compound in terms of gas permeability; i.e., gas resistance.

Using the uppermost surface layer of a photoconductive layer, the uppermost surface layer including a three-dimensionally crosslinked film formed through polymerization reaction among the compounds each containing a charge transporting compound and three or more [(tetrahydro-2H-pyran-2-yl)oxy]methyl groups bound to one or more aromatic rings thereof and having an ionization potential of 5.4 or higher can provide an electrophotographic photoconductor excellent in charging stability, NOx resistance, mechanical durability and environmental stability. Also, the three-dimensionally crosslinked film is a cured product of the charge transporting compound alone and thus exhibits good charge transporting property. In addition, the three-dimensionally crosslinked film appropriately contains electrically inactive sites that do not directly contribute to charge transportation, such as the [(tetrahydro-2H-pyran-2-yl)oxy]methyl groups, and thus is excellent in charging stability. Furthermore, the three-dimensionally crosslinked film does not contain any polar group such as a hydroxyl group and thus is excellent in environmental stability and gas resistance, capable of forming a desired electrophotographic photoconductor.

The ionization potential in the present invention is defined as follows. Specifically, the ionization potential is measured with an apparatus for photoelectron spectroscopy in air (AC-1, AC-2, AC-3: product of RIKEN KEIKI Co., Ltd.) through photoelectron yield spectroscopy or PYS. The ionization potential is calculated through plotting based on ⅓ power of photoelectron yield proposed in the following literature as an analysis method of inonization potential of organic compounds: M. Kochi, Y. Harada, T. Hirooka and H. Inokuchi: “Photoemission form Organic Crystal in Vacuum Ultraviolet Region. IV”, Bull. Chem. Soc. Jpn., 43, 2690 (1970).

### <Conductive Substrate>

The conductive substrate is not particularly limited, so long as it exhibits a volume resistivity of 10¹⁰ Ω·cm or less, and may be appropriately selected depending on the intended purpose. Examples thereof include coated products formed by coating, on film-form or cylindrical plastic or paper, a metal (e.g, aluminum, nickel, chromium, nichrome, copper, gold, silver or platinum) or a metal oxide (e.g., tin oxide or indium oxide) through vapor deposition or sputtering; and also include an aluminum plate, an aluminum alloy plate, a nickel plate and a stainless steel plate. Furthermore, there may be used tubes produced as follows: the above metal plate is formed into a raw tube through extrusion, pultrusion, etc. and then subjected to surface treatments such as cutting, superfinishing and polishing. Also, an endless nickel belt or an endless stainless-steel belt described in JP-A No. 52-36016 may be used as the substrate.

Besides, the conductive substrate usable may be the above conductive substrates additionally provided with a conductive layer formed through coating of a dispersion liquid of conductive powder in an appropriate binder resin.

Examples of the conductive powder include carbon black, acethylene black; powder of a metal such as aluminum, nickel, iron, nichrome, copper, zinc or silver; and powder of a metal oxide such as conductive tin oxide or ITO. Examples of the binder resin which is used together with the conductive powder include thermoplastic resins, thermosetting resins and photocurable resins such as polystyrene resins, styrene-acrylonitrile copolymers, styrene-butadiene copolymers, styrene-maleic anhydride copolymers, polyester resins, polyvinyl chloride resins, vinyl chloride-vinyl acetate copolymers, polyvinyl acetate resins, polyvinylidene chloride resins, polyarylate resins, phenoxy resins, polycarbonate resins, cellulose acetate resins, ethyl cellulose resins, polyvinyl butyral resins, polyvinyl formal resins, polyvinyl toluene resins, poly-N-vinylcarbazole, acrylic resins, silicone resins, epoxy resins, melamine resins, urethane resins, phenol resins and alkyd resins.

Such a conductive layer may be formed through coating of a dispersion liquid of the conductive powder and the binder resin in an appropriate solvent (e.g., tetrahydrofuran, dichloromethane, methyl ethyl ketone or toluene).

In addition, suitably used as the above substrate in the present invention is a substrate formed by providing an appropriate cylindrical support with, as a conductive layer, a heat-shrinkable tubing containing the conductive powder and a material such as polyvinyl chloride, polypropylene, polyester, polystyrene, polyvinylidene chloride, polyethylene, chlorinated rubber or Teflon (registered trademark).

### <Photoconductive Layer>

The photoconductive layer contains a charge generation layer, a charge transport layer and a crosslinked charge transport layer in this order; i.e., the charge transport layer is located between the charge generation layer and the crosslinked charge transport layer. The crosslinked charge transport layer is preferably the uppermost surface layer of the photoconductive layer.

### <<Uppermost Surface Layer (Crosslinked Charge Transport Layer)>>

The uppermost surface layer includes a three-dimensionally crosslinked film formed through polymerization reaction among compounds each containing a charge transporting compound and three or more [(tetrahydro-2H-pyran-2-yl)oxy]methyl groups bound to one or more aromatic rings thereof and having an ionization potential of 5.4 or higher. The ionization potential of the three-dimensionally crosslinked film is preferably 5.4 to 5.6, more preferably 5.4 to 5.5.

The three-dimensionally crosslinked film is a structure formed as follows. Specifically, the compounds each containing a charge transporting compound and three or more [(tetrahydro-2H-pyran-2-yl)oxy]methyl groups bound to one or more aromatic rings thereof bind with one another after some of the [(tetrahydro-2H-pyran-2-yl)oxy]methyl groups have partially been cleaved and eliminated, to thereby form a macromolecule having a three-dimensional network structure; and other of the [(tetrahydro-2H-pyran-2-yl)oxy]methyl groups remain as is.

Although there has not been elucidated the reaction in which some of the [(tetrahydro-2H-pyran-2-yl)oxy]methyl groups are partially cleaved and eliminated, the polymerization reaction therebetween is not a single reaction but a reaction in which a plurality of reactions as shown below competitively proceed to link the compounds together.

Next will be described the compound containing a charge transporting compound and three or more [(tetrahydro-2H-pyran-2-yl)oxy]methyl groups bound to one or more one aromatic rings thereof.

Many materials have conventionally been known as charge transporting compounds. Most of these materials have aromatic rings. For example, there is at least one aromatic ring in any of a triarylamine structure, an aminobiphenyl structure, a benzidine structure, an aminostilbene structure, a naphthalenetetracarboxylic acid diimide structure and a benzylhydrazine structure. There can be used any of compounds each having any of these charge transporting compounds and three or more [(tetrahydro-2H-pyran-2-yl)oxy]methyl groups, as substituents, bound to one or more aromatic rings thereof.

The following exemplary compounds can be used to form a three-dimensionally crosslinked film having the above ionization potential of 5.4 or higher and formed through polymerization reaction among the compounds each containing three or more [(tetrahydro-2H-pyran-2-yl)oxy]methyl groups and a charge transporting compound having one or more aromatic rings, the [(tetrahydro-2H-pyran-2-yl)oxy]methyl groups being present on the aromatic rings.

Preferred are a compound having three or more [(tetrahydro-2H-pyran-2-yl)oxy]methyl groups and a charge transporting compound having a triarylamine structure where the [(tetrahydro-2H-pyran-2-yl)oxy]methyl groups are present on the aromatic rings of the charge transporting compound; and a compound containing three or more [(tetrahydro-2H-pyran-2-yl)oxy]methyl groups and a charge transporting compound having two triarylamine structures where the [(tetrahydro-2H-pyran-2-yl)oxy]methyl groups are present on the aromatic rings of the charge transporting compound and the two triarylamine structures are linked together in a nonconjugate manner.

More preferred are a compound having three or more [(tetrahydro-2H-pyran-2-yl)oxy]methyl groups and a charge transporting compound having a triphenylamine structure where the [(tetrahydro-2H-pyran-2-yl)oxy]methyl groups are present on the aromatic rings of the charge transporting compound; and a compound containing three or more [(tetrahydro-2H-pyran-2-yl)oxy]methyl groups and a charge transporting compound having two triphenylamine structures where the [(tetrahydro-2H-pyran-2-yl)oxy]methyl groups are present on the aromatic rings of the charge transporting compound and the two triphenylamine structures are linked together in a nonconjugate manner.

The compound containing a charge transporting compound and three or more [(tetrahydro-2H-pyran-2-yl)oxy]methyl groups bound to one or more aromatic rings thereof is preferably a compound represented by the following General Formula (1).

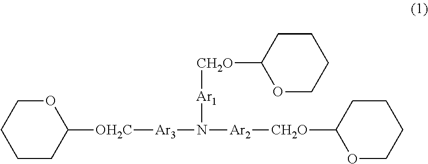

In General Formula (1), Ar₁, Ar₂ and Ar₃ each denote a divalent group of a C6-C12 aromatic hydrocarbon group which may have an alkyl group as a substituent.

Although any of the compounds each containing the above charge transporting compound and three or more [(tetrahydro-2H-pyran-2-yl)oxy]methyl groups bound to one or more aromatic rings thereof could form a three-dimensionally crosslinked film through polymerization reaction, the compound represented by General Formula (1) has a large amount of the [(tetrahydro-2H-pyran-2-yl)oxy]methyl groups relative to the molecular weight thereof. Thus, this compound can form a three-dimensionally crosslinked film having a high crosslink density, and can provide a photoconductor having high hardness and high scratch resistance.

In General Formula (1), examples of the alkyl group in Ar₁, Ar₂ and Ar₃ include linear or branched aliphatic alkyl groups such as methyl, ethyl, propyl, butyl, pentyl, hexyl, heptyl and octyl.

In General Formula (1), examples of the C6-C12 aromatic hydrocarbon group in Ar₁, Ar₂ and Ar₃ include benzene, naphthalene and biphenyl.

Also, the compound containing a charge transporting compound and three or more [(tetrahydro-2H-pyran-2-yl)oxy]methyl groups bound to one or more aromatic rings is preferably a compound represented by the following General Formula (2).

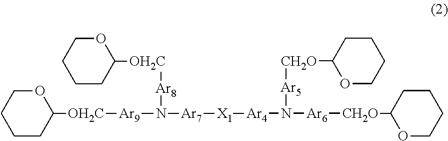

In General Formula (2), X₁ denotes a C1-C4 alkylene group, a C2-C6 alkylidene group, a divalent group formed of two C2-C6 alkylidene groups bonded together via a phenylene group, or an oxygen atom, and Ar₄, Ar₅, Ar₆, Ar₇, Ar₈ and Ar₉ each denote a divalent group of a C6-C12 aromatic hydrocarbon group which may have an alkyl group as a substituent.

In General Formula (2), examples of the C6-C12 aromatic hydrocarbon group in the divalent groups denoted by Ar₄, Ar₅, Ar₆, Ar₇, Ar₈ and Ar₉ include the same as exemplified in the divalent groups denoted by Ar₁, Ar₂ and Ar₃ in General Formula (1).

Examples of the C1-C4 alkylene group denoted by X₁ in General Formula (2) include linear or branched alkylene groups such as methylene, ethylene, propylene and butylene.

Examples of the C2-C6 alkylidene group denoted by X₁ in General Formula (2) include 1,1-ethylidene, 1,1-propylidene, 2,2-propylidene, 1,1-butylidene, 2,2-butylidene, 3,3-pentanylidene and 3,3-hexanylidene.

Examples of the divalent group X₁ formed of two C2-C6 alkylidene groups bonded together via a phenylene group in General Formula (2) include the following groups:

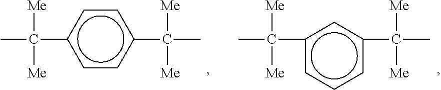

where Me denotes a methyl group.

The compound represented by General Formula (2) contains a charge transporting compound and three or more [(tetrahydro-2H-pyran-2-yl)oxy]methyl groups bound to one or more aromatic rings thereof, and also contains a nonconjugated linking group denoted by X₁ and thus has an appropriate molecular mobility. Through polymerization reaction, this compound can easily form a three-dimensionally crosslinked film in which some of the [(tetrahydro-2H-pyran-2-yl)oxy]methyl groups remain as is. The formed three-dimensionally crosslinked film achieves a favorable balance between hardness and elasticity, making it possible to form a stiff surface protective layer excellent in scratch resistance and abrasion resistance. Furthermore, by virtue of the structure of X₁, the molecule has a relatively high oxidation potential not to be easily oxidized. Thus, this is relatively stable when exposed to oxidative gas such as ozone gas or NOx gas, making it possible to provide a photoconductor having excellent gas resistance.

When the three-dimensionally crosslinked film is insoluble to a solvent, it exhibits remarkably excellent mechanical properties. The compound containing a charge transporting compound and three or more [(tetrahydro-2H-pyran-2-yl)oxy]methyl groups bound to one or more aromatic rings thereof dissolves in tetrahydrofuran in a large amount. Once this compounds react and bond with one another to form a three-dimensionally network structure, the resultant product no longer dissolves in tetrahydrofuran or any other solvents.

Thus, the fact that the three-dimensionally crosslinked film is insoluble to tetrahydrofuran means that a macromolecule has been formed in the surface of the photoconductor and the obtained photoconductor exhibits high mechanical properties (mechanical durability).

Here, the “being insoluble” means a state where the film does not disappear even when immersed in tetrahydrofuran.

More preferably, this state is a state where even when the film is rubbed with a swab, etc. soaked in tetrahydrofuran, there is no trace left in the film.

When the film is allowed to be insoluble to a solvent, foreign matter can be prevented from adhering to the photoconductor, and also the photoconductor surface can be prevented from being scratched due to adhesion of the foreign matter.

Also, the compound containing a charge transporting compound and three or more [(tetrahydro-2H-pyran-2-yl)oxy]methyl groups bound to one or more aromatic rings is preferably a compound represented by the following General Formula (3).

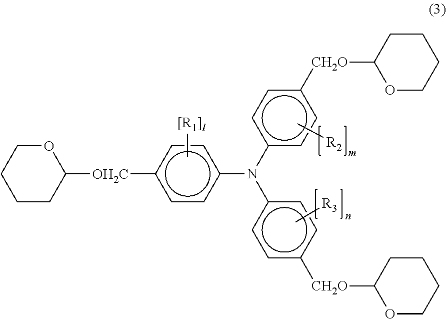

In General Formula (3), R₁, R₂ and R₃, which may be the same or different, each denote a hydrogen atom, a methyl group or an ethyl group; and l, n and m each denote an integer of 1 to 4.

The compound represented by General Formula (3) is particularly excellent among the compounds represented by General Formula (1), and has particularly high polymerization reactivity. Although the polymerization reaction among the [(tetrahydro-2H-pyran-2-yl)oxy]methyl groups is still unclear, when the aromatic rings having the [(tetrahydro-2H-pyran-2-yl)oxy]methyl groups are benzene rings having a tertiary amino group, the polymerization reaction proceeds at the highest rate. As a result, it is possible to form a crosslinked protective layer (crosslinked charge transport layer) having higher crosslink density.

Also, the compound containing a charge transporting compound and three or more [(tetrahydro-2H-pyran-2-yl)oxy]methyl groups bound to one or more aromatic rings is preferably a compound represented by the following General Formula (4).

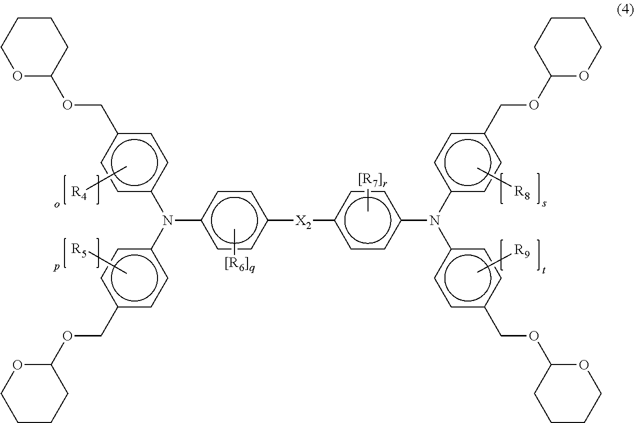

In General Formula (4), X₂ denotes —CH₂—, —CH₂CH₂—, —C(CH₃)₂-Ph-C(CH₃)₂—, —C(CH₂)₅— or —O—; R₄, R₅, R₆, R₇, R₈ and R₉, which may be the same or different, each denote a hydrogen atom, a methyl group or an ethyl group; and o, p, q, r, s and t each denote an integer of 1 to 4.

The compound represented by General Formula (4) is particularly excellent among the compounds represented by General Formula (2), and has high polymerization reactivity. This compound has the same features as those of the compound represented by General Formula (2), making it possible to form a three-dimensionally crosslinked film (crosslinked charge transport layer) having a high crosslink density.

Specific examples of the compound containing a charge transporting compound and three or more [(tetrahydro-2H-pyran-2-yl)oxy]methyl groups bound to one or more aromatic rings thereof will be given below; however, the present invention should not be construed as being limited thereto.

TABLE 1

| Compd. | |
|---|---|
| No. | Chemical Structure |
| 1 | 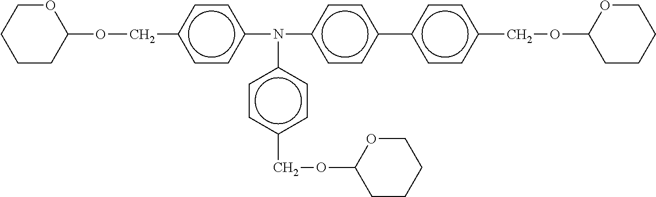 |
| 2 | 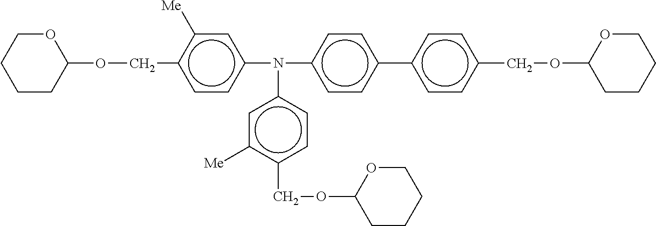 |
| 3 | 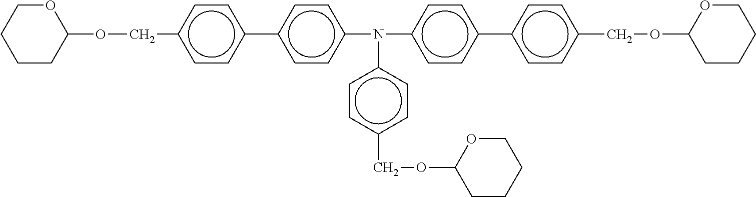 |
| 4 | 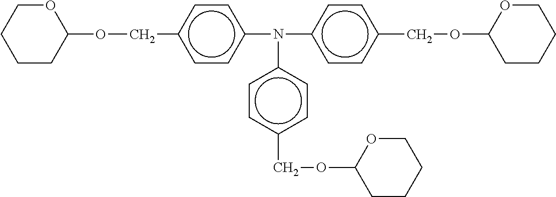 |
| 5 | 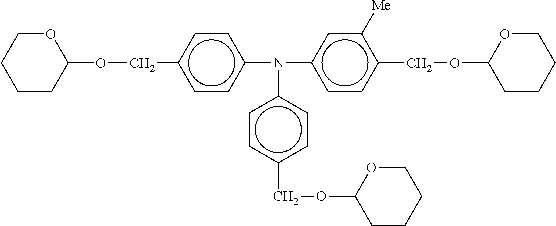 |
| 6 | 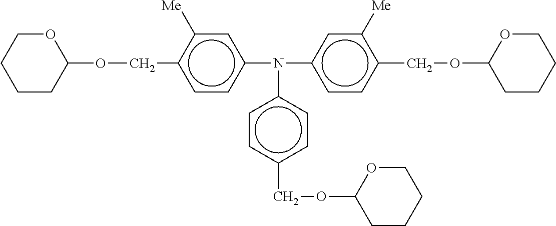 |
| 7 | 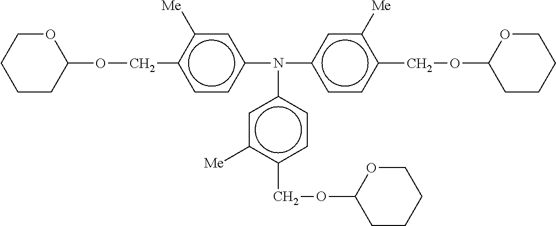 |
| 8 | 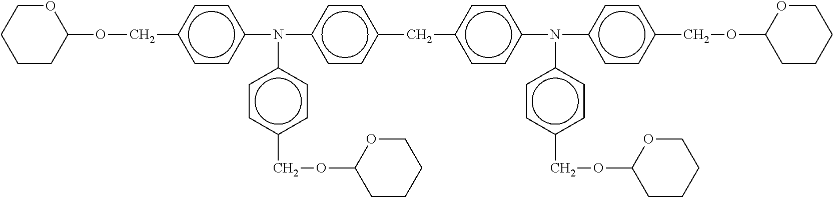 |
| 9 | 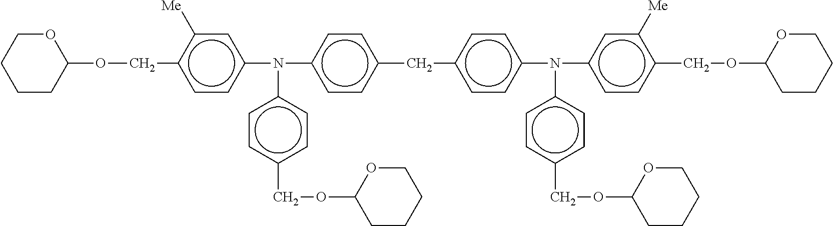 |
| 10 | 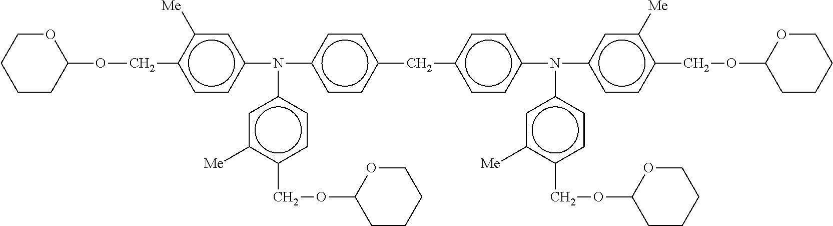 |
| 11 | 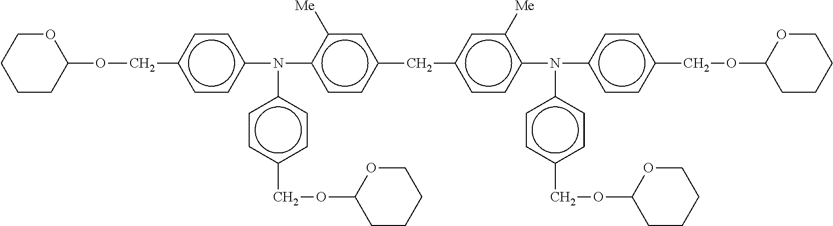 |
| 12 | 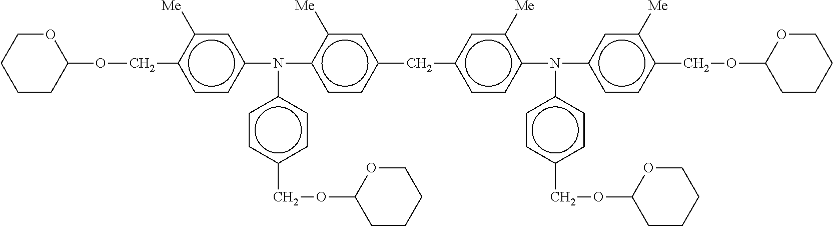 |
| 13 | 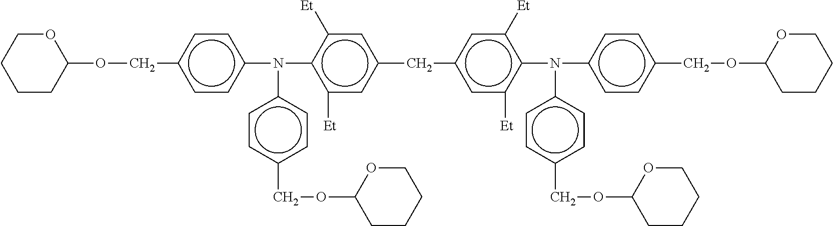 |
| 14 | 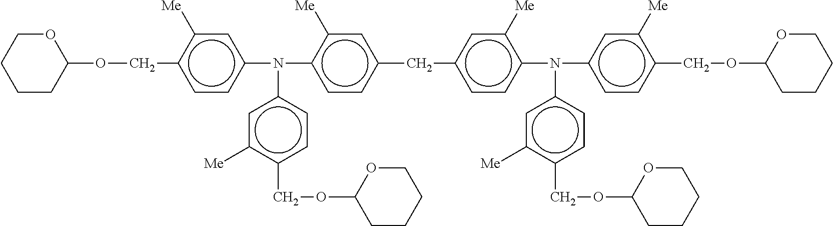 |
| 15 | 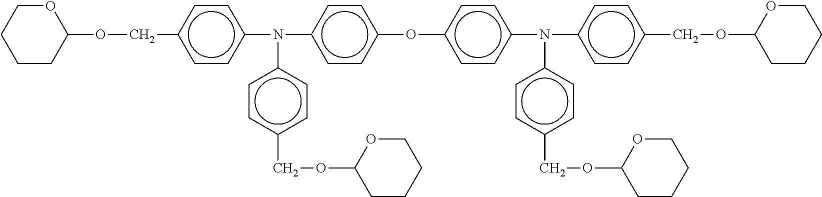 |
| 16 | 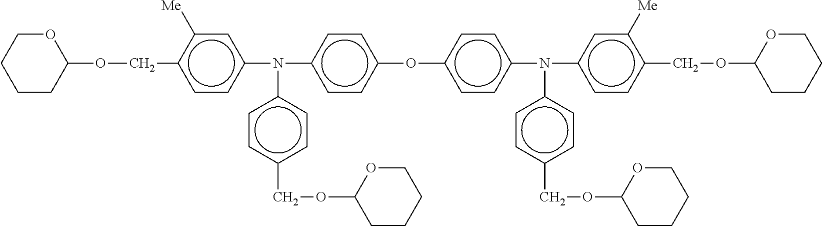 |
| 17 | 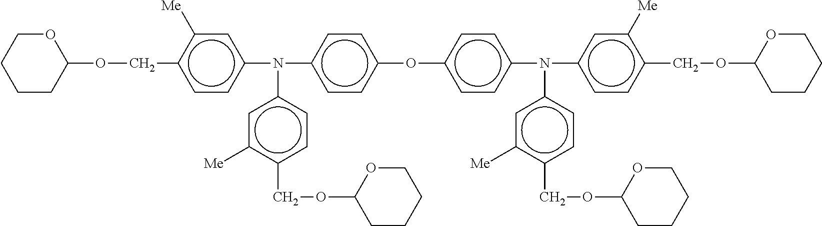 |
| 18 | 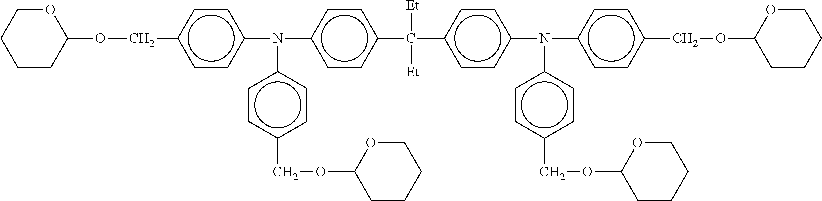 |
| 19 | 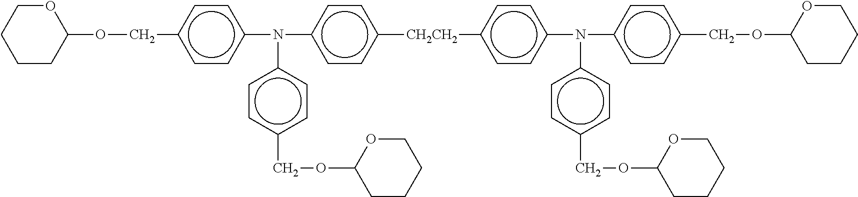 |
| 20 | 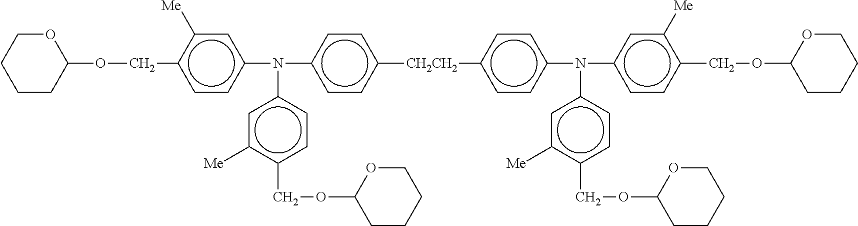 |
| 21 | 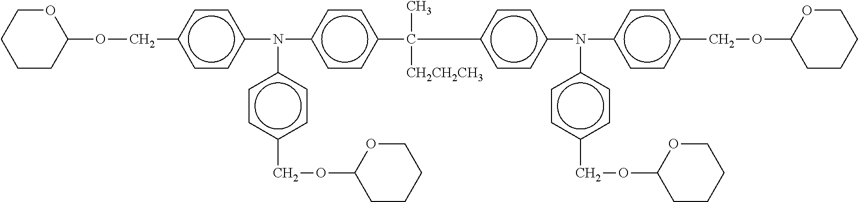 |
| 22 | 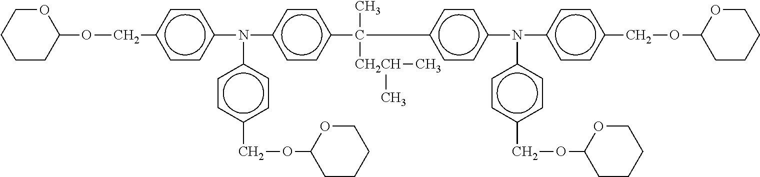 |
| 23 | 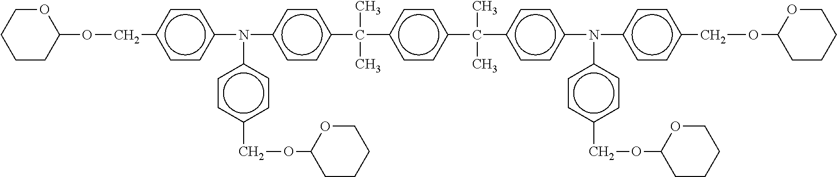 |
| 24 | 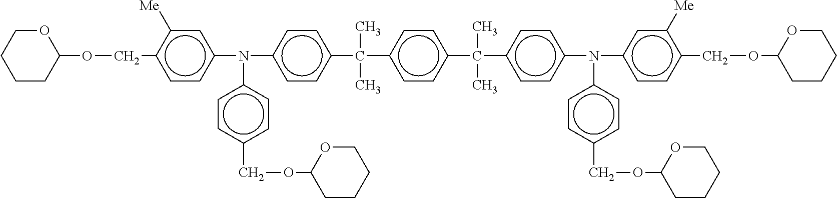 |
| 25 | 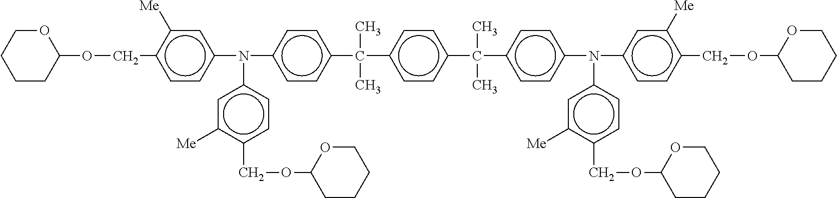 |
| 26 | 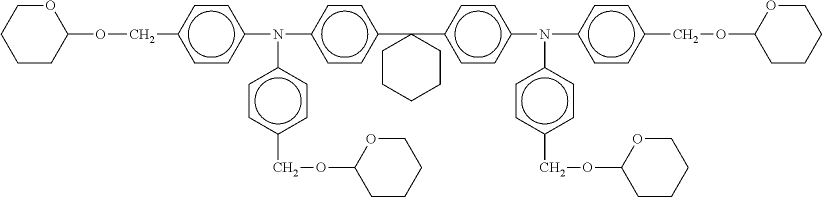 |
| 27 | 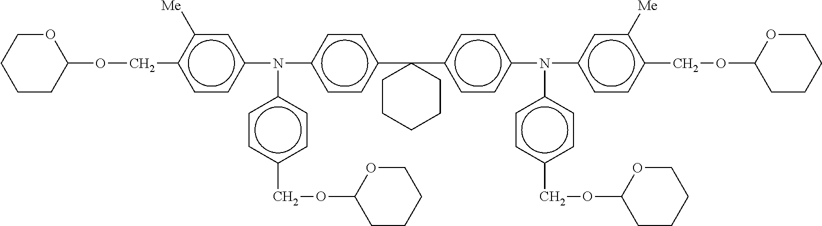 |
| 28 | 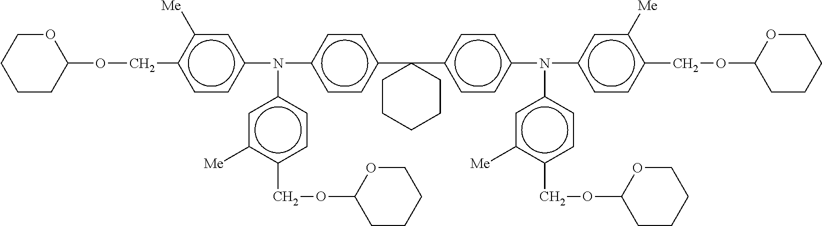 |
| 29 | 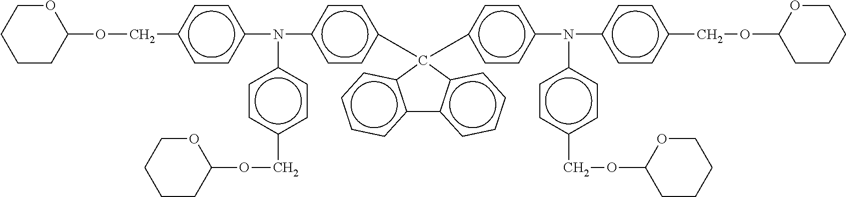 |
| 30 | 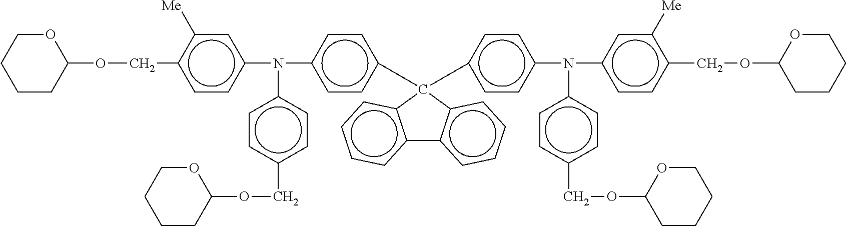 |

The above-described compound containing a charge transporting compound and three or more [(tetrahydro-2H-pyran-2-yl)oxy]methyl groups bound to one or more aromatic rings thereof is a novel compound and can be produced by, for example, the following method.

### —Synthesis Method for the Compound Containing a Charge Transporting Compound and Three or More [(Tetrahydro-2H-Pyran-2-Yl)Oxy]Methyl Groups Bound to One or More Aromatic Rings Thereof—

### —First Synthesis Method—

In a first synthesis method, three or more aromatic rings of a charge transporting compound are formylated to form formyl groups; the thus-formed formyl groups are then reduced to form methylol groups; and the thus-formed methylol groups are then reacted with 3,4-dihydro-2H-pyran to form [(tetrahydro-2H-pyran-2-yl)oxy]methyl groups on the charge transporting compound.

In one employable method, an aldehyde compound is synthesized according to the below-described procedure; the obtained aldehyde compound is reacted with a reducing agent such as sodium borohydride to synthesize a methylol compound; the obtained methylol compound is reacted with dihydro-2H-pyran to obtain a compound containing a charge transporting compound and [(tetrahydro-2H-pyran-2-yl)oxy]methyl groups bound to one or more aromatic rings thereof. Specifically, this compound can easily be synthesized in the following production method.

### —Second Synthesis Method—

A second synthesis method is a method using as a starting material a compound having aromatic rings each having a halogen atom and a methylol group. In this method, the methylol groups are reacted with 3,4-dihydro-2H-pyran in the presence of an acid catalyst to synthesize an aromatic compound having halogen atoms and [(tetrahydro-2H-pyran-2-yl)oxy]methyl groups; and the thus-synthesized aromatic compound is coupled with an amine compound to synthesize the charge transporting compound.

Depending on the number of amines or on whether the amine is primary, secondary or tertiary, it is possible to introduce many [(tetrahydro-2H-pyran-2-yl)oxy]methyl groups at one time. When the halogen is iodine (i.e., iodine compound), the amine compound can be coupled through Ullmann reaction with the halogen (iodine) compound having the [(tetrahydro-2H-pyran-2-yl)oxy]methyl groups. When the halogen is chlorine (i.e., chlorine compound) or bromine (i.e., bromine compound), the amine compound can be coupled therewith through, for example, Suzuki-Miyaura reaction using a palladium catalyst.

### —Synthesis of Aldehyde Compound—

As shown in the following reaction formula, a charge transporting compound, serving as a starting material, can be formylated by a conventionally known method (e.g., Vilsmeier reaction) to synthesize an aldehyde compound. For example, this formylation can be performed as described in JP-B No. 3943522.

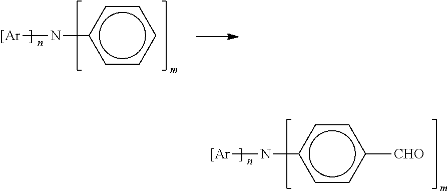

Specifically, it is effective that this formylation method is a method using zinc chloride/phosphorus oxychloride/dimethylformaldehyde. However, the synthesis method for the aldehyde compound, which is an intermediate used in the present invention, should not be construed as being limited thereto. Specific synthesis examples will be given as the below-described Synthesis Examples.

Adjustment of the formylation conditions and purification can easily form a trifunctional aldehyde compound. In this manner, it is possible to synthesize an intermediate aldehyde compound of compound H used in Comparative Example 9 described below.

### —Synthesis of Methylol Compound—

As shown in the following reaction formula, the aldehyde compound, serving as a production intermediate, can be reduced by a conventionally known method to synthesize a methylol compound.

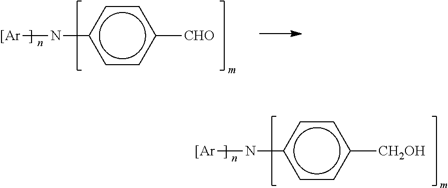

Specifically, it is effective that this reduction method is a method using sodium borohydride. However, the synthesis method for the methylol compound should not be construed as being limited thereto. Specific synthesis examples will be given in the below-described Examples.

### —Synthesis of the Compound Containing a Charge Transporting Compound and [(Tetrahydro-2H-Pyran-2-Yl)Oxy]Methyl Groups Bound to One or More Aromatic Rings Thereof [1]—

As shown in the following reaction formula, the methylol compound, serving as a production intermediate, can be added with 3,4-dihydro-2H-pyran in the presence of a catalyst to synthesize the compound containing a charge transporting compound and [(tetrahydro-2H-pyran-2-yl)oxy]methyl groups bound to one or more aromatic rings thereof.

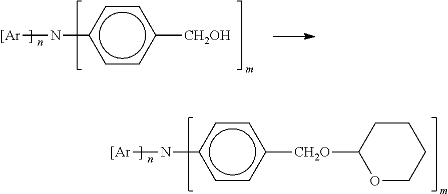

Specifically, it is effective that this synthesis method is a method using dihydro-2H-pyran. However, the synthesis method for the compound of the present invention containing a charge transporting compound and [(tetrahydro-2H-pyran-2-yl)oxy]methyl groups bound to one or more aromatic rings thereof should not be construed as being limited thereto. Specific synthesis examples will be given in the below-described Examples.

### —Synthesis of an Intermediate Compound Having a [(Tetrahydro-2H-Pyran-2-Yl)Oxy]Methyl Group—

The synthesis method for an intermediate compound having a [(tetrahydro-2H-pyran-2-yl)oxy]methyl group is, for example, a method in which a compound having an aromatic ring with a halogen atom and a methylol group is used as a starting material; and the methylol group is reacted with 3,4-dihydro-2H-pyran in the presence of an acid catalyst to synthesize an intermediate compound having a halogen atom and a [(tetrahydro-2H-pyran-2-yl)oxy]methyl group.

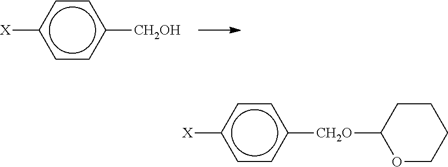

In this reaction formula, X denotes halogen.

### —Synthesis of the Compound Containing a Charge Transporting Compound and [(Tetrahydro-2H-Pyran-2-Yl)Oxy]Methyl Groups Bound to One or More Aromatic Rings Thereof [2]—

As shown in the following reaction formula, an amine compound and a halogen compound with a tetrahydropyranyl group, serving as product intermediates, can be used to synthesize, with a conventionally known method, the compound containing a charge transporting compound and [(tetrahydro-2H-pyran-2-yl)oxy]methyl groups bound to one or more aromatic rings thereof.

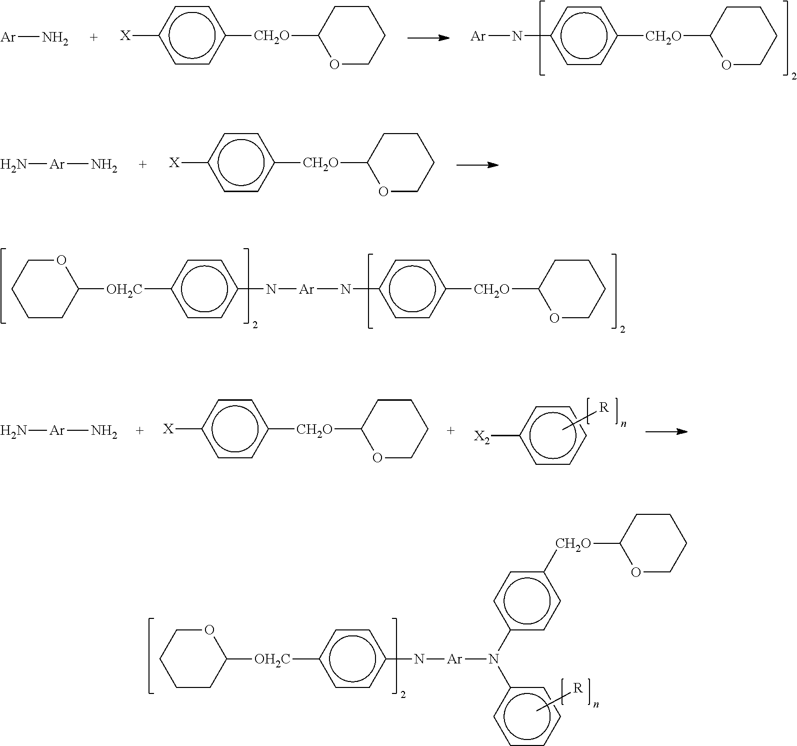

Specifically, it is effective that this synthesis method is a method using, for example, Ullmann reaction. However, the synthesis method for the compound of the present invention containing a charge transporting compound and [(tetrahydro-2H-pyran-2-yl)oxy]methyl groups bound to one or more aromatic rings thereof should not be construed as being limited thereto. Specific synthesis examples will be given in the below-described Examples.

### —Polymerization Reaction (Reaction Mode)—

Although there has not been elucidated the reaction in which some of the [(tetrahydro-2H-pyran-2-yl)oxy]methyl groups are partially cleaved and eliminated, the polymerization reaction therebetween is not a single reaction but a reaction in which a plurality of reactions as shown below competitively proceed to link the compounds together.

The reaction mode is shown below.

### —Reaction Mode 1

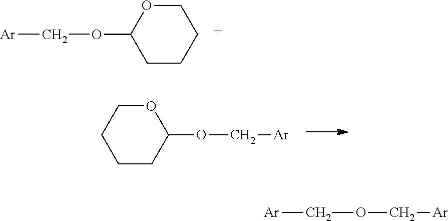

In the above reaction formula, Ar denotes any aromatic ring of the charge transporting compound used in the present invention.

In this reaction, the tetrahydro-2H-pyran-2-yl group of one [(tetrahydro-2H-pyran-2-yl)oxy]methyl group is cleaved and eliminated; and then, while the (tetrahydro-2H-pyran-2-yl)oxy group of the other [(tetrahydro-2H-pyran-2-yl)oxy]methyl group is being cleaved and eliminated, a dimethylene ether bond is formed therebetween.

### —Reaction Mode 2—

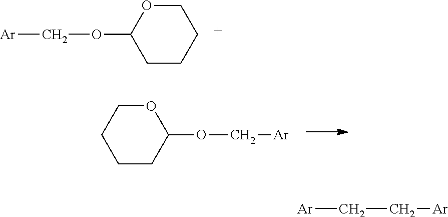

In the above reaction formula, Ar denotes any aromatic ring of the charge transporting compound used in the present invention.

In this reaction, while the (tetrahydro-2H-pyran-2-yl)oxy groups of both the [(tetrahydro-2H-pyran-2-yl)oxy]methyl groups are being cleaved and eliminated, an ethylene bond is formed therebetween.

### —Reaction Mode 3—

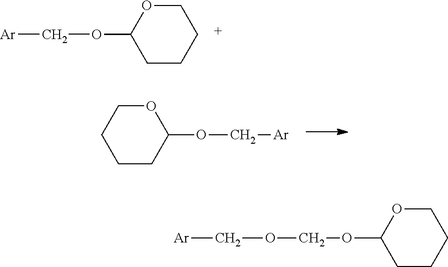

In the above reaction formula, Ar denotes any aromatic ring of the charge transporting compound used in the present invention.

In this reaction, while the (tetrahydro-2H-pyran-2-yl)oxy group of one [(tetrahydro-2H-pyran-2-yl)oxy]methyl group is being cleaved and eliminated, the one [(tetrahydro-2H-pyran-2-yl)oxy]methyl group binds with the aromatic ring of the other [(tetrahydro-2H-pyran-2-yl)oxy]methyl group to form a methylene bond therebetween.

Through combination of at least these reactions, the [(tetrahydro-2H-pyran-2-yl)oxy]methyl groups are polymerized so as to have various bonds, to thereby form a macromolecule having a three-dimensional network structure.

The (tetrahydro-2H-pyran-2-yl)oxy group is generally known as a protective group of a hydroxyl group. In the three-dimensionally crosslinked film (cured film) of the present invention, the [(tetrahydro-2H-pyran-2-yl)oxy]methyl groups remain. Thus, presumably, deprotection reaction does not occur. In other words, the [(tetrahydro-2H-pyran-2-yl)oxy]methyl group is not hydrolyzed to change into a methylol group.

In addition, the (tetrahydro-2H-pyran-2-yl)oxy group has a low polarity and thus, the unreacted, remaining (tetrahydro-2H-pyran-2-yl)oxy group does not adversely affect electrical characteristics or image quality.

The polymerization reaction tends to form a film having severe distortion. However, relatively bulky [(tetrahydro-2H-pyran-2-yl)oxy]methyl groups remaining have an effect of reducing such distortion, and also can be expected to compensate molecular spaces formed through distortion, making it possible to form a film having low gas permeability and higher stiffness; i.e., lower brittleness.

It is possible to desirably change the amount of the [(tetrahydro-2H-pyran-2-yl)oxy]methyl groups reacted or unreacted (remaining) in the molecule, in order to adjust the structure of the charge transporting compound and obtain the desired film properties. However, when the amount of the [(tetrahydro-2H-pyran-2-yl)oxy]methyl groups remaining is too small, the formed film involves severe distortion and brittleness, and is not suitable to a long-service-life photoconductor. Meanwhile, it is necessary to increase the reaction temperature, in order to increase the amount of the [(tetrahydro-2H-pyran-2-yl)oxy]methyl groups reacted. In this case, the heat degrades photoconductivity of the formed photoconductor, leading to problems such as decrease in sensitivity and increase in residual potential. When the amount of the [(tetrahydro-2H-pyran-2-yl)oxy]methyl groups remaining is too large, the formed film decreases in crosslink density and in some cases, dissolves in an organic solvent; i.e., poorly crosslinked state. As a result, it does not exhibit excellent mechanical properties attributed to the three-dimensionally crosslinked film. Thus, it is preferred to select such curing conditions as to give a film having both favorable mechanical properties and favorable electrostatic properties.

The three-dimensionally crosslinked film in the electrophotographic photoconductor of the present invention is preferably obtained through polymerization reaction among the compounds each containing a charge transporting compound and three or more [(tetrahydro-2H-pyran-2-yl)oxy]methyl groups bound to one or more aromatic rings thereof in the presence of a curing catalyst.

Use of the curing catalyst under heating allows the polymerization reaction to proceed at a practical rate, making it possible to form the uppermost surface layer excellent in surface smoothness. When the surface smoothness is considerably degraded, cleanability of toner particles are also degraded to cause formation of abnormal images; i.e., inhibit high-quality printing. When an appropriate curing catalyst is used under heating at an appropriate temperature, it is possible to form a three-dimensionally crosslinked film excellent in surface smoothness. When this three-dimensionally crosslinked film is used as the uppermost surface layer of the photoconductive layer of the electrophotographic photoconductor, the formed electrophotographic photoconductor can form (print) high-quality images for a long period of time.

### —Formation Method for Three-Dimensionally Crosslinked Film—

The three-dimensionally crosslinked film can be formed as follows. Specifically, a coating liquid containing the curing catalyst and the compound containing a charge transporting compound and three or more [(tetrahydro-2H-pyran-2-yl)oxy]methyl groups bound to one or more aromatic rings thereof is prepared or diluted optionally using, for example, a solvent; and the obtained coating liquid is coated on the photoconductor surface and heated and dried to perform polymerization. In an alternative manner, two or more types of the compound containing a charge transporting compound and three or more [(tetrahydro-2H-pyran-2-yl)oxy]methyl groups bound to one or more aromatic rings thereof are used in combination and mixed together, and the resultant mixture is used to form the three-dimensionally crosslinked film in the same manner as described above.

The temperature for heating the coating liquid is preferably 80° C. to 180° C., more preferably 100° C. to 160° C. Since the reaction rate can change depending on the type or amount of a catalyst used, the heating temperature may desirably be determined in consideration of the formulation of the coating liquid. Although, the reaction rate becomes higher with increasing the heating temperature, an extreme increase in crosslink density leads to a decrease in charge transporting property whereby the formed photoconductor is increased in exposed-area potential and decreased in sensitivity. In addition, the other layers of the photoconductor are increasingly affected due to heating, easily degrading the properties of the formed photoconductor. When the heating temperature is too low, the reaction rate is also low and as a result, a sufficient crosslink density cannot be achieved even when performing the reaction for a long period of time.

The curing catalyst is preferably an acid compound, more preferably an organic sulfonic acid, an organic sulfonic acid derivative, etc. Examples of the organic sulfonic acid include p-toluenesulfonic acid, naphthalenesulfonic acid and dodecylbenzenesulfonic acid. Further examples include organic sulfonic acid salts, and so-called thermally latent compounds showing acidity at a certain temperature or higher. Examples of the thermally latent compound include thermally latent proton acid catalysts blocked with an amine such as NACURE2500, NACURE5225, NACURE5543 or NACURE5925 (these products are of King Industries, Inc.), SI-60 (product of Sanshin Chemical Industry Co.) and ADEKAOPTOMER SP-300 (product of ADEKA CORPORATION).

The above catalyst is added to the coating liquid in an amount (solid content concentration) of about 0.02% by mass to about 5% by mass. When an acid such as p-toluenesulfonic acid is used alone, an amount of about 0.02% by mass to about 0.4% by mass is enough. When the amount is too large, the coating liquid is increased in acidity to cause corrosion of coating apparatus, etc., which is not preferred. In contrast, use of the thermally latent compound does not involve problems such as corrosion at the step of coating the coating liquid and thus, it is possible to increase the amount of the thermally latent compound. However, the remaining amine compound used as the blocking agent adversely affects the properties of the photoconductor such as residual potential. Thus, use of the thermally latent compound in an extremely large amount is not preferred. Since the thermally latent compound contains an acid in a smaller amount in the case of the acid alone, the amount of the thermally latent compound (catalyst) is properly 0.2% by mass to 2% by mass.

When the heating/drying temperature and time are appropriately selected considering the type or amount of a catalyst as described above, it is possible to form three-dimensionally crosslinked films of the present invention having various crosslink densities.

Examples of the solvent include alcohols such as methanol, ethanol, propanol and butanol; ketons such as acetone, methyl ethyl ketone, methyl isobutyl ketone and cyclohexanone; esters such as ethyl acetate and butyl acetate; ethers such as tetrahydrofuran, methyltetrahydrofuran, dioxane, propylether, diethylene glycol dimethyl ether and propylene glycol-1-monomethyl ether-2-acetate; halogen-containing compounds such as dichloromethane, dichloroethane, trichloroethane and chlorobenzene; aromatic compounds such as benzene, toluene and xylene; and cellosolves such as methyl cellosolve, ethyl cellosolve and cellosolve acetate. These solvents may be used alone or in combination. The dilution rate by the solvent may be appropriately determined depending on the dissolvability of the composition, the coating method employed and/or the thickness of an intended film. The coating of the coating liquid can be performed by, for example, a dip coating method, a spray coating method, a bead coating method or a ring coating method.

If necessary, the coating liquid may further contain an additive such as a leveling agent or an antioxidant. Examples of the leveling agent include silicone oils such as dimethylsilicone oil and methylphenylsilicone oil; and polymers and oligomers each having a perfluoroalkyl group in the side chain thereof. The amount of the leveling agent is preferably 1% by mass or less relative to the total solid content of the coating liquid. The antioxidant can suitably be used. Examples of the antioxidant include conventionally known compounds such as phenol compounds, paraphenylenediamines, hydroquinones, organic sulfur compounds, organic phosphorus compounds and hindered amines. The antioxidant is effective for stabilizing electrostatic properties during repetitive use. The amount of the antioxidant is preferably 1% by mass or less relative to the total solid content of the coating liquid.

Furthermore, the coating liquid may contain a filler in order for the formed film to be increased in abrasion resistance. The filler is classified into organic filler materials and inorganic filler materials. Examples of the organic filler materials include fluorine resin powder such as polytetrafluoroethylene, silicone resin powder and α-carbon powder. Examples of the inorganic filler materials include powders of metals such as copper, tin, aluminum and indium; metal oxides such as silica, tin oxide, zinc oxide, titanium oxide, alumina, zirconium oxide, indium oxide, antimony oxide, bismuth oxide, calcium oxide, tin oxide doped with antimony, and indium oxide doped with tin; and inorganic materials such as potassium titanate and boron nitride. Among them, use of inorganic materials is advantageous from the viewpoint of increasing abrasion resistance, since they have higher hardness. In particular, α-type alumina is useful from the viewpoint of increasing abrasion resistance, since it has high insulating property, high thermal stability, and a hexagonal close-packed structure exhibiting high abrasion resistance.

Moreover, the filler can be surface-treated with at least one surface treating agent. The filler is preferably surface-treated therewith since its dispersibility increases. Decrease in dispersibility of the filler causes not only an increase in residual potential but also a decrease in transparency of the coated film, formation of defects in the coated films, and a decrease in abrasion resistance, potentially leading to severe problems that inhibit high durability or high quality image formation.

The surface treating agent may be any conventionally-used surface treating agent, but preferably used is a surface treating agent able to maintain the insulating property of the filler. From the viewpoints of improving filler dispersibility and preventing image blur, such surface treating agent is more preferably a titanate coupling agent, an aluminum coupling agent, a zircoaluminate coupling agent, a higher fatty acid, mixtures containing these agents or acids and a silane coupling agent; Al₂O₃, TiO₂, ZrO₂, silicone, aluminum stearate and mixtures thereof. A treatment with a silane coupling agent alone causes a considerable degree of image blur, while a treatment with the mixture containing the above surface treating agent and a silane coupling agent may suppress such disadvantageous effect caused by the silane coupling agent.

The amount of the surface treating agent varies with the average primary particle diameter of the filler, but is preferably 3% by mass to 30% by mass, more preferably 5% by mass to 20% by mass. When the surface treating agent is less than the lower limit, it cannot exhibit an effect of dispersing the filler. Whereas when the surface treating agent is too large, it causes a considerable increase in residual potential. Also, the average primary particle diameter of the filler is preferably 0.01 μm to 0.5 μm from the viewpoint of improving optical transmittance and abrasion resistance. When the average primary particle diameter of the filler is less than 0.01 abrasion resistance, dispersibility, etc. are decreased. Whereas when it is more than 0.5 μm, there may be a case where the filler easily sediments and toner filming occurs.

The amount of the filler is preferably 5% by mass to 50% by mass, more preferably 10% by mass to 40% by mass. When it is less than 5% by mass, sufficient abrasion resistance cannot be obtained. Whereas when it is more than 50% by mass, transparency is degraded.

After coating of the above coating liquid, a heating and drying step is performed for curing. A dissolution test using an organic solvent is performed to obtain an index of reactivity of curing. The dissolution test means a test where the surface of the cured product is rubbed with a swab soaked in an organic solvent having high dissolution capability such as tetrahydrofuran and then observed. The coated film where the curing reaction has not occurred is dissolved. The coated film where the curing reaction has insufficiently proceeded is swollen and peeled off. The coated film where the curing reaction has sufficiently proceeded is insoluble.

The three-dimensionally crosslinked film in the electrophotographic photoconductor of the present invention has the highest level of charge transporting property among the conventional crosslinked films, but its charge transporting property is still lower than that of common molecule-dispersed charge transport layers. Thus, the best performance can be obtained when using the conventional molecule-dispersed charge transport layer as a charge transport layer and using the three-dimensionally crosslinked film as a protective layer thereof.

That is, formation of a thin-film crosslinked charge transport layer on a relatively thick common molecule-dispersed charge transport layer can provide an electrophotographic photoconductor having the above-described advantageous features without involving a decrease in sensitivity. Thus, the thickness of the crosslinked charge transport layer is preferably 1 μm to 10 μm.

### <<Charge Generation Layer>>

The charge generation layer contains at least a charge generating compound; preferably contains a binder resin; and, if necessary, further contains other ingredients.

The charge generating compound may be an inorganic material or an organic material.

Examples of the inorganic material include crystalline selenium, amorphous selenium, selenium-tellurium, selenium-tellurium-halogen, a selenium-arsenic compound and amorphous silicone. As the amorphous silicone, preferably used is amorphous silicone in which the dangling bonds are terminated with hydrogen atoms or halogen atoms or amorphous silicone with which a boron atom or a phosphorus atom is doped.

The organic material is not particularly limited and may be appropriately selected from known materials depending on the intended purpose. Examples thereof include phthalocyanine pigments such as metal phthalocyanines and metal-free phthalocyanines; azulenium salt pigments, methine squarate pigments, azo pigments having a carbazole skeleton, azo pigments having a triphenylamine skeleton, azo pigments having a diphenylamine skeleton, azo pigments having a dibenzothiophene skeleton, azo pigments having a fluorenone skeleton, azo pigments having an oxadiazole skeleton, azo pigments having a bis-stilbene skeleton, azo pigments having a distilyloxadiazole skeleton, azo pigments having a distilylcarbazole skeleton, perylene pigments, anthraquinone and multicyclic quinone pigments, quinoneimine pigments, diphenylmethane and triphenylmethane pigments, benzoquinone and naphthoquinone pigments, cyanine and azomethine pigments, indigoido pigments and bis-benzimidazole pigments. These may be used alone or in combination.

The binder resin is not particularly limited and may be appropriately selected depending on the intended purpose. Examples thereof include polyamide resins, polyurethane resins, epoxy resins, polyketone resins, polycarbonate resins, silicone resins, acrylic resins, polyvinylbutylal resins, polyvinylformal resins, polyvinyl ketone resins, polystyrene resins, poly-N-vinylcarbazol resins and polyacrylamide resins. These may be used alone or in combination.

In addition to the above-listed binder resins, further examples of the binder resin used in the charge generation layer include charge transpotable polymers having a charge transporting function, such as (1) polymer materials including polycarbonate resins, polyester resins, polyurethane resins, polyether resins, polysiloxane resins and acrylic resins which each have an arylamine skeleton, benzidine skeleton, hydrazone skeleton, carbazol skeleton, stilbene skeleton and/or pyrrazoline skeleton; and (2) polymer materials each having a polysilane skeleton.

Specific examples of the polymer materials described in (1) above include charge transportable polymer materials described in, for example, JP-A Nos. 01-001728, 01-009964, 01-013061, 01-019049, 01-241559, 04-011627, 04-175337, 04-183719, 04-225014, 04-230767, 04-320420, 05-232727, 05-310904, 06-234836, 06-234837, 06-234838, 06-234839, 06-234840, 06-234841, 06-239049, 06-236050, 06-236051, 06-295077, 07-056374, 08-176293, 08-208820, 08-211640, 08-253568, 08-269183, 09-062019, 09-043883, 09-71642, 09-87376, 09-104746, 09-110974, 09-110976, 09-157378, 09-221544, 09-227669, 09-235367, 09-241369, 09-268226, 09-272735, 09-302084, 09-302085 and 09-328539.

Specific examples of the polymer materials described in (2) above include polysilylene polymers described in, for example, JP-A Nos. 63-285552, 05-19497, 05-70595 and 10-73944.

The charge generation layer may further contain a low-molecular-weight charge transporting compound.

The low-molecular-weight charge transporting compound is classified into a hole transporting compound and an electron transporting compound.

Examples of the electron transporting compound include chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophen-4-one, 1,3,7-trinitrodibenzothiophene-5,5-dioxide and diphenoquinone derivatives. These may be used alone or in combination.

Examples of the hole transporting compound include oxazole derivatives, oxadiazole derivatives, imidazole derivatives, monoarylamine derivatives, diarylamine derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bis-stilbene derivatives, enamine derivatives, and other known materials. These may be used alone or in combination.

The method for forming the charge generation layer is mainly a vacuum thin-film formation method and a casting method using a solution dispersion system.

Examples of the vacuum thin-film formation method include a vacuum evaporation method, a glow discharge decomposition method, an ion plating method, a sputtering method, a reactive sputtering method and a CVD method.

The casting method includes: dispersing the organic or inorganic charge generating compound and an optionally used binder resin in a solvent (e.g., tetrahydrofuran, dioxane, dioxolan, toluene, dichloromethane, monochlorobenzene, dichloroethane, cyclohexanone, cyclopentanone, anisole, xylene, methyl ethyl ketone, acetone, ethyl acetate or butyl acetate) using a ball mill, an attritor, a sand mill or a beads mill, thereby obtaining a dispersion liquid; and appropriately diluting the obtained dispersion liquid and coating the diluted dispersion liquid. The dispersion liquid may optionally contain a leveling agent such as a dimethyl silicone oil or methylphenyl silicone oil. The coating can be performed by, for example, a dip coating method, a spray coating method, a bead coating method and a ring coating method.

The thickness of the charge generation layer is not particularly limited and may be appropriately selected depending on the intended purpose. It is preferably 0.01 μm to 5 μm, more preferably 0.05 μm to 2 μm.

### <<Charge Transport Layer>>

The charge transport layer is a layer provided for the purposes of retaining charges and transferring charges generated from the charge generation layer through exposure to combine them together. In order to satisfactorily retain charges, the charge transport layer is required to have high electrical resistance. Meanwhile, in order to obtain high surface potential due to the retained charges, the charge transport layer is required to have low dielectric constant and good charge transferability.

The charge transport layer contains at least a charge transporting compound; preferably contains a binder resin; and, if necessary, further contains other ingredients.

Examples of the charge transporting compound include hole transporting compounds, electron transporting compounds and charge transporting polymers.

Examples of the electron transporting compound (electron accepting compound) include chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophen-4-one and 1,3,7-trinitrodibenzothiophene-5,5-dioxide. These may be used alone or in combination.

Examples of the hole transporting compound (electron donating compound) include oxazole derivatives, oxadiazole derivatives, imidazole derivatives, triphenylamine derivatives, 9-(p-diethyleaminostyrylanthracene), 1,1-bis-(4-dibenzylaminophenyl)propane, styrylanthracene, styrylpyrazoline, phenylhydrazons, α-phenylstilbene derivatives, thiazole derivatives, triazole derivatives, phenazine derivatives, acridine derivatives, benzofuran derivatives, benzimidazole derivatives and thiophene derivatives. These may be used alone or in combination.

Examples of the charge transporting polymers include those having the following structures.

(a) Examples of polymers having a carbazole ring include poly-N-vinylcarbazole and the compounds described in, for example, JP-A Nos. 50-82056, 54-9632, 54-11737, 04-175337, 04-183719 and 06-234841.
(b) Examples of polymers having a hydrazon structure include compounds described in, for example, JP-A Nos. 57-78402, 61-20953, 61-296358, 01-134456, 01-179164, 03-180851, 03-180852, 03-50555, 05-310904 and 06-234840.
(c) Examples of polysilylene polymers include the compounds described in, for example, JP-A Nos. 63-285552, 01-88461, 04-264130, 04-264131, 04-264132, 04-264133 and 04-289867.
(d) Examples of polymers having a triarylamine structure include N,N-bis(4-methylphenyl)-4-aminopolystyrene and the compounds described in, for example, JP-A Nos. 01-134457, 02-282264, 02-304456, 04-133065, 04-133066, 05-40350 and 05-202135.
(e) Examples of other polymers include nitropyrene-formaldehyde polycondensates and the compounds described in, for example, JP-A Nos. 51-73888, 56-150749, 06-234836 and 06-234837.

In addition to the above-listed compounds, further examples of the charge transporting compound include polycarbonate resins having a triarylamine structure, polyurethane resins having a triarylamine structure, polyester resins having a triarylamine structure, and polyether resins having a triarylamine structure. Further examples of the charge transporting polymers include the compounds described in, for example, JP-A Nos. 64-1728, 64-13061, 64-19049, 04-11627, 04-225014, 04-230767, 04-320420, 05-232727, 07-56374, 09-127713, 09-222740, 09-265197, 09-211877 and 09-304956.

In addition to the above-listed polymers, further examples of the polymer having an electron donating group include copolymers, block polymers, graft polymers and star polymers, each being formed of known monomers, as well as crosslinked polymers having an electron donating group as described in JP-A No. 03-109406.

Examples of the binder resin include polycarbonate resins, polyester resins, methacryl resins, acryl resins, polyethylene resins, polyvinyl chloride resins, polyvinyl acetate resins, polystyrene resins, phenol resins, epoxy resins, polyurethane resins, polyvinylidene chloride resins, alkyd resins, silicone resins, polyvinylcarbazole resins, polyvinylbutyral resins, polyvinylformal resins, polyacrylate resins, polyacrylamide resins and phenoxy resins. These may be used alone or in combination.

Notably, the charge transport layer may contain a copolymer of a crosslinkable binder resin and a crosslinkable charge transporting compound.

The charge transport layer can be formed as follows. Specifically, these charge transporting compound and binder resin are dissolved or dispersed in an appropriate solvent, and the resultant solution or dispersion liquid is coated and then dried. If necessary, the charge transport layer may further contain an appropriate amount of additives such as a plasticizer, an antioxidant and a leveling agent, in addition to the charge transporting compound and the binder resin.

The solvent used for the coating of the charge transport layer may be the same as used for the coating of the charge generation layer. Suitably used are solvents that dissolve the charge transporting compound and the binder resin in sufficient amounts. These solvents may be used alone or in combination. The formation of the charge transport layer can be performed by the same coating method as employed for the formation of the charge generation layer. If necessary, a plasticizer and a leveling agent may be added.

The plasticizer may be a plasticizer for common resins, such as dibutylphthalate and dioctyphthalate. The amount of the plasticizer used is properly about 0 parts by mass to about 30 parts by mass per 100 parts by mass of the binder resin.

Examples of the leveling agent include silicone oils such as dimethylsilicone oil and methylphenylsilicone oil; and polymers and oligomers each having a perfluoroalkyl group in the side chain thereof. The amount of the leveling agent used is properly about 0 parts by mass to about 1 part by mass per 100 parts by mass of the binder resin.

The thickness of the charge transport layer is not particularly limited and may be appropriately selected depending on the intended purpose. It is preferably 5 μm to 40 μm, more preferably 10 μm to 30 μm.

### <Intermediate Layer>

In the electrophotographic photoconductor of the present invention, an intermediate layer may be provided between the charge transport layer and the crosslinked charge transport layer, for the purpose of preventing charge transport layer's components from being included in the crosslinked charge transport layer or improving adhesiveness between the layers.

Thus, the intermediate layer is suitably made of a material insoluble or poorly-soluble to the crosslinked charge transport layer-coating liquid. In general, it is made mainly of a binder resin. Examples of the binder resin include polyamide, alcohol-soluble nylon, water-soluble polyvinyl butyral, polyvinyl butyral and polyvinyl alcohol. The intermediate layer is formed by any of the above coating methods. The thickness of the intermediate layer is not particularly limited and may be appropriately selected depending on the intended purpose. It is suitably 0.05 μm to 2 μm.

### <Under Layer>

In the electrophotographic photoconductor of the present invention, an under layer may be provided between the conductive substrate and the photoconductive layer. In general, the under layer is made mainly of resin. Preferably, the resin is highly resistant to a commonly used organic solvent, in consideration of subsequent formation of the photoconductive layer using the solvent. Examples of the resin include water-soluble resins (e.g., polyvinyl alcohol, casein and sodium polyacrylate); alcohol-soluble resins (e.g, nylon copolymers and methoxymethylated nylon); and curable resins forming a three-dimensional network structure (e.g., polyurethane, melamine resins, phenol resins, alkyd-melamine resins and epoxy resins). The under layer may contain fine pigment particles of a metal oxide such as titanium oxide, silica, alumina, zirconium oxide, tin oxide or indium oxide, for the purpose of, for example, preventing moire generation and reducing residual potential.

The under layer may also be an Al₂O₃ film formed by anodic oxidation; a film formed by vacuum thin film formation from an organic material (e.g., polyparaxylene (parylene)) or an inorganic material (e.g., SiO₂, SnO₂, TiO₂, ITO or CeO₂); or other known films.

Similar to the formation of the photoconductive layer, the under layer can be formed using an appropriate solvent and a coating method. In the present invention, the under layer may also be formed of a silane coupling agent, a titanium coupling agent or a chromium coupling agent. The thickness of the under layer is not particularly limited and may be appropriately selected depending on the intended purpose. It is preferably 0 μm to 5 μm.

The under layer may be in the form of a laminated layer of two or more different layers made of the different materials listed above.

### <Addition of Antioxidant to Each Layer>

In the electrophotographic photoconductor of the present invention, for the purpose of improving environmental stability, in particular, preventing reduction of sensitivity and increase in residual potential, an antioxidant may be incorporated into each of the crosslinked charge transport layer, the charge transport layer, the charge generation layer, the under layer, the intermediate layer, etc.

Examples of the antioxidant include phenol compounds, paraphenylenediamines, hydroquinones, organic sulfur-containing compounds and organic phosphorus-containing compounds. These may be used alone or in combination.

Examples of the phenol compound include 2,6-di-t-butyl-p-cresol, butylated hydroxyanisole, 2,6-di-t-butyl-4-ethylphenol, stearyl-β-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butylic acid]glycol ester and tocopherols.

Examples of the paraphenylenediamine include
N-phenyl-N′-isopropyl-p-phenylenediamine,
N,N′-di-sec-butyl-p-phenylenediamine,
N-phenyl-N-sec-butyl-p-phenylenediamine,
N,N′-di-isopropyl-p-phenylenediamine and
N,N′-dimethyl-N,N′-di-t-butyl-p-phenylenediamine.

Examples of the hydroquinone include 2,5-di-t-octylhydroquinone, 2,6-didodecylhydroquinone, 2-dodecylhydroquinone, 2-dodecyl-5-chlorohydroquinone, 2-t-octyl-5-methylhydroquinone and 2-(2-octadecenyl)-5-methylhydroquinone.

Examples of the organic sulfur-containing compound include dilauryl-3,3′-thiodipropionate, distearyl-3,3′-thiodipropionate and ditetradecyl-3,3′-thiodipropionate.

Examples of the organic phosphorus-containing compound include triphenyl phosphine, tri(nonylphenyl)phosphine, tri(dinonylphenyl)phosphine, tricresylphosphine and tri(2,4-dibutylphenoxy)phosphine.

Notably, these compounds are known as antioxidants for rubber, plastic and fats and oils, and their commercially available products can easily be obtained.

The amount of the antioxidant added is not particularly limited and may be appropriately selected depending on the intended purpose. It is preferably 0.01% by mass to 10% by mass relative to the total mass of the layer to which the antioxidant is added.

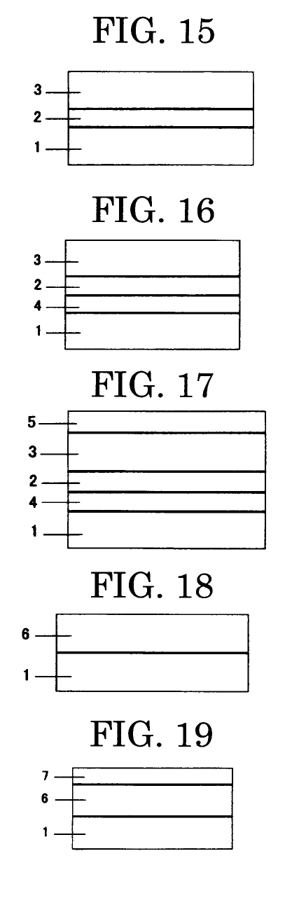

Referring to FIGS. 15 to 19, next will be described the layer structure of the electrophotographic photoconductor of the present invention. FIGS. 15 to 19 are cross-sectional views of the electrophotographic photoconductors having different photoconductor structures.

FIG. 15 is a cross-sectional view of the structure of the most basic multi-layer photoconductor, where a charge generation layer 2 and a charge transport layer 3 are laminated on a conductive substrate 1 in this order. When the photoconductor is negatively charged in use, the charge transport layer contains a hole transportable charge transporting compound. When the photoconductor is positively charged in use, the charge transport layer contains an electron transportable charge transporting compound.

In this case, the uppermost surface layer is a charge transport layer 3. Thus, this charge transport layer includes the three-dimensionally crosslinked film of the present invention which is formed through polymerization reaction among the compounds each containing a charge transporting compound and three or more [(tetrahydro-2H-pyran-2-yl)oxy]methyl groups bound to one or more aromatic rings thereof.

FIG. 16 is a cross-sectional view of the structure of the most practical photoconductor, which is the same as the most basic multi-layer photoconductor except that an under layer 4 is additionally formed. Also in this case, the uppermost surface layer is the charge transport layer 3. Thus, this charge transport layer includes the three-dimensionally crosslinked film of the present invention which is formed through polymerization reaction among the compounds each containing a charge transporting compound and three or more [(tetrahydro-2H-pyran-2-yl)oxy]methyl groups bound to one or more aromatic rings thereof.

FIG. 17 is a cross-sectional view of the structure of a photoconductor which is the same as the most practical photoconductor of FIG. 16 except that a crosslinked charge transport layer 5 is further provided on the uppermost surface as a protective layer. Thus, this crosslinked charge transport layer includes the three-dimensionally crosslinked film of the present invention which is formed through polymerization reaction among the compounds each containing a charge transporting compound and three or more [(tetrahydro-2H-pyran-2-yl)oxy]methyl groups bound to one or more aromatic rings thereof.

Here, the under layer is not an essential layer but is generally formed, since it plays an important role in, for example, preventing leakage of charges.

In the photoconductor of FIG. 17, two separate layers: the charge transport layer 3 and the crosslinked charge transport layer 5 are responsible for charge transfer from the charge generation layer to the photoconductor, making it possible for different layers to have different functions (i.e., separate a main function). For example, combinational use of a charge transport layer excellent in charge transporting property and a crosslinked charge transport layer excellent in mechanical strength can provide a photoconductor excellent in both charge transporting property and mechanical strength.

The three-dimensionally crosslinked film of the present invention formed through polymerization reaction among the compounds each containing a charge transporting compound and three or more [(tetrahydro-2H-pyran-2-yl)oxy]methyl groups bound to one or more aromatic rings thereof is a crosslinked film relatively excellent in charge transporting property and can satisfactorily be used as the charge transport layer 3. However, it is inferior in charge transporting property to the conventional molecule-dispersed charge transport layer. Thus, the three-dimensionally crosslinked film of the present invention is preferably as a relatively thin film. The most excellent photoconductor can be obtained when using the three-dimensionally crosslinked film as a thin film.

When the three-dimensionally crosslinked film of the present invention is used as a crosslinked charge transport layer, the thickness of the three-dimensionally crosslinked film is preferably 1 μm to 10 μm, more preferably 3 μm to 8 μm, as described above. When it is too thin, the formed photoconductor cannot have a sufficiently long service life. When it is too thick, the formed photoconductor tends to decrease in sensitivity and increase in exposed-area potential, making it difficult to stably form images.

FIG. 18 is a cross-sectional view of the structure of a photoconductor where a conductive substrate 1 is provided thereon with a photoconductive layer 6 mainly containing a charge generating compound and a charge transport compound. The photoconductive layer 6 may include the three-dimensionally crosslinked film of the present invention which is formed through polymerization reaction among the compounds each containing a charge transporting compound and three or more [(tetrahydro-2H-pyran-2-yl)oxy]methyl groups bound to one or more aromatic rings thereof. In this case, it is necessary to incorporate the charge generating compound into the crosslinked film. Thus, the three-dimensionally crosslinked film is produced as follows. Specifically, the charge generating compound is mixed with or dispersed in the above coating liquid, and the resultant coating liquid is coated, followed by heating and drying for performing polymerization reaction.

FIG. 19 is a cross-sectional view of the structure of a photoconductor where a protective layer 7 is formed on the single-layer photoconductive layer 6. This protective layer 7 includes the three-dimensionally crosslinked film of the present invention which is formed through polymerization reaction among the compounds each containing a charge transporting compound and three or more [(tetrahydro-2H-pyran-2-yl)oxy]methyl groups bound to one or more aromatic rings thereof.

The other layers than the layer including the three-dimensionally crosslinked film of the present invention may be conventionally known layers.

### Image Forming Method and Image Forming Apparatus

An image forming method of the present invention includes: a charging step of charging a surface of an electrophotographic photoconductor; an exposing step of exposing the charged surface of the electrophotographic photoconductor to light to form a latent electrostatic image; a developing step of developing the latent electrostatic image with a toner to form a visible image; a transfer step of transferring the visible image onto a recording medium; and a fixing step of fixing the transferred visible image on the recording medium, wherein the electrophotographic photoconductor is the electrophotographic photoconductor of the present invention. Use of the electrophotographic photoconductor of the present invention can provide an image forming method which can highly stably form images during repetitive use, which can maintain high image quality with less image defects for a long period of time, and which is excellent in environmental stability and gas resistance.

Also, the image forming method of the present invention is preferably an image forming method where the latent electrostatic image is digitally formed on the photoconductor in the exposing step. This preferable image forming method can respond efficiently to output of documents and images from PC and have the same features as in the above image forming method.

An image forming apparatus of the present invention includes: an electrophotographic photoconductor; a charging unit configured to charge a surface of the electrophotographic photoconductor; an exposing unit configured to expose the charged surface of the electrophotographic photoconductor to light to form a latent electrostatic image; a developing unit configured to develop the latent electrostatic image with a toner to form a visible image; a transfer unit configured to transfer the visible image onto a recording medium; and a fixing unit configured to fix the transferred visible image on the recording medium, wherein the electrophotographic photoconductor is the electrophotographic photoconductor of the present invention. Use of the electrophotographic photoconductor of the present invention can provide an image forming apparatus which can highly stably form images during repetitive use, which can maintain high image quality with less image defects for a long period of time, and which is excellent in environmental stability and gas resistance.

Also, in the image forming apparatus of the present invention, preferably, the latent electrostatic image is digitally formed on the electrophotographic photoconductor with the exposing unit. This preferable image forming apparatus can respond efficiently to output of documents and images from PC and have the same features as in the above image forming apparatus.

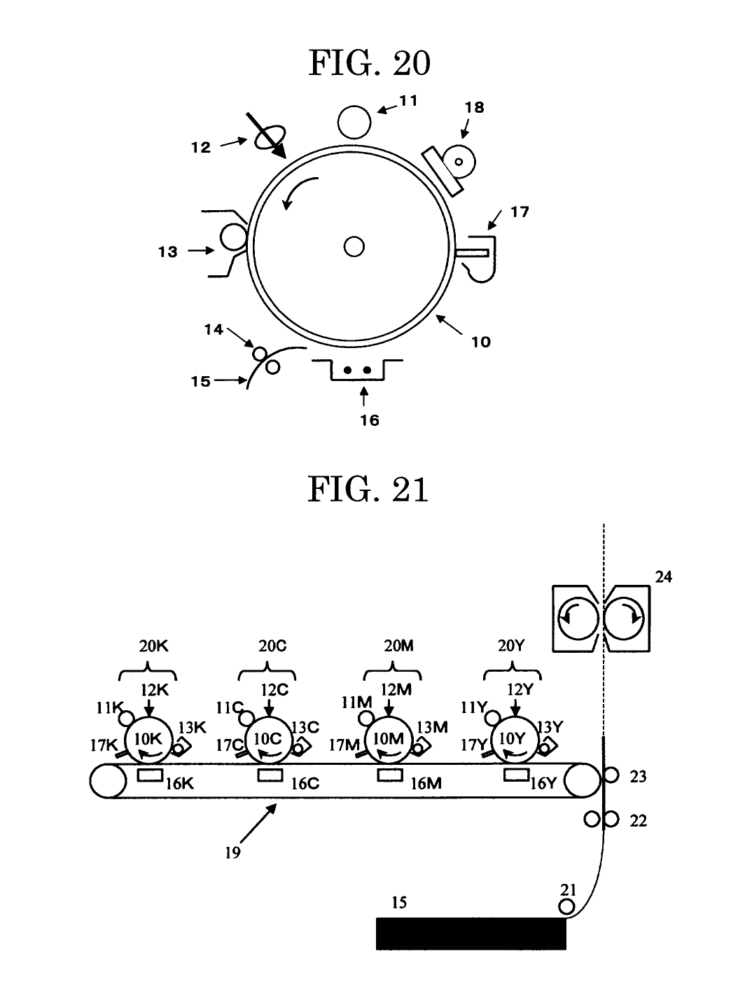

Referring to the drawings, next will be described in detail the image forming method and the image forming apparatus of the present invention. FIG. 20 is an explanatory, schematic view of an electrophotographic process and image forming apparatus of the present invention. The present invention encompasses the following embodiment.

A photoconductor 10 is rotated in the arrow direction in FIG. 20. Around the photoconductor 10 are provided a charging member 11 serving as the charging unit, a developing member 13 serving as the developing unit, a transfer member 16, a cleaning member 17 serving as the cleaning unit, a charge-eliminating member 18 serving as the charge-eliminating unit, etc. The cleaning member 17 and/or the charge-eliminating member 18 may be omitted.

The basic operation of the image forming apparatus is as follows. First, the charging member 11 charges almost uniformly the surface of the photoconductor 10. Subsequently, laser light 12 emitted from an image exposing member serving as the exposing unit writes an image correspondingly to input signals, to thereby form a latent electrostatic image. Next, the developing member 13 develops the latent electrostatic image to form a toner image on the photoconductor surface. The formed toner image is transferred with the transfer member 16 onto an image receiving paper sheet 15 which has been conveyed to a transfer position with conveyance rollers 14. This toner image is fixed on the image receiving paper sheet 15 with a fixing device serving as the fixing unit. Some toner particles remaining after transfer onto the image receiving paper sheet 15 are cleaned with the cleaning member 17. Next, the charges remaining on the photoconductor 10 are eliminated with the charge-eliminating member 18, and then the next cycle starts.

As shown in FIG. 20, the photoconductor 10 has a shape of drum. Alternatively, the photoconductor 10 may have a shape of sheet or endless belt. The charging member 11 or the transfer member 16 may use any of known chargers such as a corotron, a scorotron, a solid state charger, a charging member having a roller shape, and a charging member of a brush shape.

The light source used in, for example, the charge-eliminating unit 18 may be a commonly-used light-emitting device such as a fluorescent lamp, a tungsten lamp, a halogen lamp, a mercury lamp, a sodium lamp, a light-emitting diode (LED), a laser diode (LD) or an electroluminescence (EL) lamp. Among them, a laser diode (LD) or a light-emitting diode (LED) is used in many cases.

Also, a filter may be used for applying light having desired wavelengths. The filter may be, for example, various filters such as a sharp-cut filter, a band-pass filter, an infrared cut filter, a dichroic filter, an interference filter and a color conversion filter.

The light source applies light to the photoconductor 10 in the transfer step, charge-eliminating step, cleaning step or pre-exposing step. Here, the exposure of the photoconductor 10 to light in the charge-eliminating step gives severe damage to the photoconductor 10, potentially causing a decrease in chargeability and an increase in residual potential.

Thus, instead of the light exposure, the charge elimination may be performed through application of opposite bias in the charging step and the cleaning step. This may be advantageous in terms of high durability of the photoconductor.

When the electophotographic photoconductor 10 is positively (negatively) charged and then imagewise exposed to light, a positive (negative) latent electrostatic image is formed on the photoconductor surface. When the positive (negative) latent electrostatic image is developed using negatively- (positively-) charged toner particles (charge-detecting microparticles), a positive image is obtained, whereas when the positive (negative) latent electrostatic image is developed using positively- (negatively-) charged toner particles, a negative image is obtained. As described above, the developing unit and the charge-eliminating unit may employ a known method.

Among the contaminants adhering to the photoconductor surface, discharged substances generated through discharging or external additives contained in the toner are susceptible to humidity, causing formation of abnormal images. Such substances that cause formation of abnormal images include paper dust, which adheres to the photoconductor to increase the frequency of abnormal image formation, to decrease the abrasion resistance and to cause uneven abrasion. For the above reason, more preferred is a configuration where the photoconductor is not in direct contact with paper, from the viewpoint of achieving high image quality.

Not all of the toner particles supplied from the developing member 13 on the photoconductor 10 are transferred onto the image receiving paper sheet 15, and some toner particles remain on the photoconductor 10. Such toner particles are removed from the photoconductor 10 with the cleaning member 17.

This cleaning member may be a known member such as a cleaning blade or a cleaning brush. The cleaning blade and the cleaning brush may also be used in combination.

Since the photoconductor of the present invention realizes high photoconductivity and high stability, it can be formed into a photoconductor having a small diameter. Thus, the photoconductor is very effectively used in a so-called tandem image forming apparatus or image forming process where a plurality of photoconductors are provided correspondingly to developing portions for color toners for performing image formation in parallel. The tandem image forming apparatus includes: at least four color toners necessary for full-color printing; i.e., yellow (C), magenta (M), cyan (C) and black (K); developing portions retaining the color toners; and at least four photoconductors corresponding to the color toners. This configuration makes it possible to perform full-color printing much faster than in conventional full-color image forming apparatus.

FIG. 21 is an explanatory, schematic view of a tandem full-color electrophotographic apparatus of the present invention. The present invention encompasses the following modification embodiment.

In FIG. 21, each of photoconductors 10C (cyan), 10M (magenta), 10Y (yellow) and 10K (black) has a drum-shaped photoconductor (10). These photoconductors 10C, 10M, 10Y and 10K are rotated in the arrow direction in FIG. 24. At least a charging member 11C, 11M, 11Y or 11K, a developing member 13C, 13M, 13Y or 13K and a cleaning member 17C, 17M, 17Y or 17K are arranged around each of the photoconductors in the rotational direction thereof.

The tandem full-color electrophotographic apparatus is configured such that the photoconductors 10C, 10M, 10Y and 10K are irradiated with laser lights 12C, 12M, 12Y and 12K emitted from image exposing members provided outside of the photoconductors 10 between the charging members 11C, 11M, 11Y and 11K and the developing members 13C, 13M, 13Y and 13K so as to form latent electrostatic images.

Four image forming units 20C, 20M, 20Y and 20K respectively containing the photoconductors 10C, 10M, 10Y and 10K, each serving as a central member, are arranged in parallel along an image receiving material conveyance belt (transfer belt) 19 serving as an image receiving material conveyance unit.

The image receiving material conveyance belt 19 is in contact with the photoconductors 10C, 10M, 10Y and 10K between the developing members 13C, 13M, 13Y and 13K and the cleaning members 17C, 17M, 17Y and 17K in the image forming units 20C, 20M, 20Y and 20K. Transfer members 16C, 16M, 16Y and 16K for applying transfer bias are disposed in the image receiving material conveyance belt 19 on the opposite surface to the photoconductors 10. The image forming units 20C, 20M, 20Y and 20K have the same configuration except that the color of the toner contained in the developing device is different from one another.

The color electrophotographic apparatus having the configuration as shown in FIG. 21 performs image formation as follows. First, in the image forming units 20C, 20M, 20Y and 20K, the photoconductors 10C, 10M, 10Y and 10K are charged with the charging members 11C, 11M, 11Y and 11K rotated in the opposite direction to that of the photoconductors 10. Next, in exposing portions provided outside the photoconductors 10, latent electrostatic images for respective color images are formed with laser lights 12C, 12M, 12Y and 12K.

Next, the developing members (13C, 13M, 13Y and 13K) develop the latent images to form toner images. The developing members (13C, 13M, 13Y and 13K) perform development using toners of C (cyan), M (magenta), Y (yellow) and K (black). The color toner images formed on the four photoconductors (10C, 10M, 10Y and 10K) are superposed on top of one another on the transfer belt 19.

The image receiving paper sheet 15 is fed from a tray with a paper feeding roller 21 and is stopped with a pair of registration rollers 22. In synchronization with image formation of the photoconductor, the image receiving paper sheet 15 is fed to the transfer member 23. The toner image retained on the transfer belt 19 is transferred onto an image receiving paper sheet 15 by the action of the electrical field formed due to the difference in potential between the transfer belt 19 and the transfer bias applied to the transfer member 23. After the image receiving paper sheet having the transferred toner image has been conveyed therefrom, the toner image is fixed on the image receiving paper sheet with the fixing member 24 and then discharged to a paper discharge section. The residual toner particles remaining after transfer on each photoconductor (10C, 10M, 10Y or 10K) are collected with each cleaning member (17C, 17M, 17Y or 17K) provided in each unit.

The intermediate transfer process as shown in FIG. 21 is particularly effective in an image forming apparatus able to perform full-color printing. By transferring a plurality of toner images onto an intermediate transfer member and transferring the toner images onto a paper sheet at one time, incomplete superposition of color images can easily prevented as well as high quality image formation can effectively performed.

The intermediate transfer member in the present invention may be any of the conventionally known intermediate transfer member, although there are intermediate transfer members of various materials or shapes, such as a drum-shaped intermediate transfer member and a belt-shaped intermediate transfer member. Use of the intermediate transfer member is effective in allowing the photoconductor to have high durability or perform high quality image formation.

Notably, in the embodiment of FIG. 24, the image forming units are arranged in the sequence of Y (yellow), M (magenta), C (cyan) and K (black) from upstream to downstream in the direction in which the image receiving paper is conveyed. The sequence of the image forming units is not limited thereto but is desirably set. It is particularly effective in the present invention to provide a mechanism with which the operations of the image forming units (20C, 20M and 20Y) are stopped when preparing documents of only black.

The image forming units as described above may be mounted to a copier, facsimile or printer in the fixed state. Alternatively, they may be mounted thereto in the form of a process cartridge.

### Process Cartridge

A process cartridge of the present invention includes: an electrophotographic photoconductor; and at least one unit selected from the group consisting of a charging unit, an exposing unit, a developing unit, a transfer unit, a cleaning unit and a charge-eliminating unit, wherein the process cartridge is detachably mounted to a main body of an image forming apparatus and wherein the electrophotographic photoconductor is the electrophotographic photoconductor of the present invention. Use of the electrophotographic photoconductor of the present invention can provide a process cartridge which can highly stably form images during repetitive use, which can maintain high image quality with less image defects for a long period of time, and which is excellent in environmental stability and gas resistance.

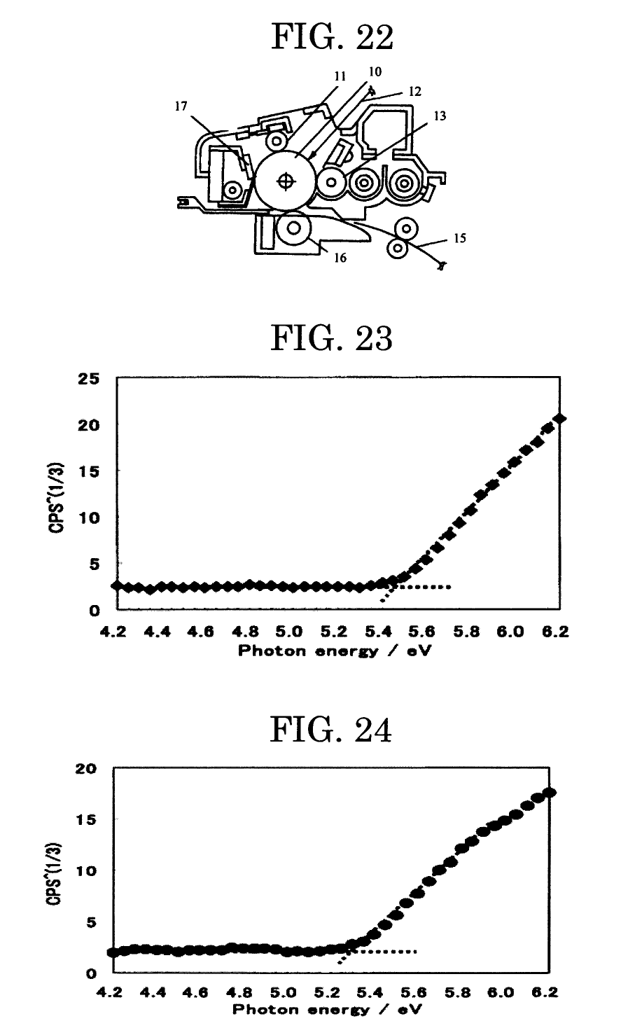

As shown in FIG. 22, the process cartridge is a single device (part) including a photoconductor 10, a charging member 11, a developing member 13, a transfer member 16, a cleaning member 17 and a charge-eliminating member. In FIG. 25, reference numeral 12 denotes laser light and reference numeral 15 denotes an image receiving paper sheet.

The above-described tandem image forming apparatus realizes high-speed full-color printing since a plurality of toner images are transferred at one time.

However, this apparatus requires at least four photoconductors and thus, is forced to be large. Also, depending on the amount of the toner used, the photoconductors differ in abrasion degree, causing many problems such as a drop in color reproducibility and formation of abnormal images.

In contrast, the photoconductor of the present invention realizes high photoconductivity and high stability and thus can be formed into a photoconductor having a small diameter. In addition, it does not involve disadvantages such as increase in residual potential and degradation of sensitivity. Therefore, even when four photoconductors are used at different frequencies, they involve small differences therebetween in residual potential and sensitivity after repetitive use. As a result, it is possible to form full-color images excellent in color reproducibility even after long-term repetitive use.

### EXAMPLES

The present invention will next be described in more detail by way of Examples, but should not be construed as being limited to the Examples. In the following Examples, the unit “part(s)” means “part(s) by mass.”

### Synthesis Example 1

### Synthesis of Halogen Intermediate

The reaction formula of Synthesis Example 1 is given below.

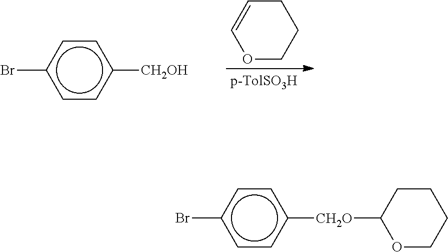

A four-neck flask was charged with 4-bromobenzyl alcohol (50.43 g), 3,4-dihydro-2H-pyran (45.35 g) and tetrahydrofuran (150 mL). The mixture was stirred at 5° C., and p-toluenesulfonic acid (0.512 g) was added to the four-neck flask. The resultant mixture was stirred at room temperature for 2 hours, and then extracted with ethyl acetate, dehydrated with magnesium sulfate, and adsorbed onto active clay and silica gel. The mixture was filtrated, washed and concentrated to obtain a compound of interest (yield: 72.50 g, a colorless oily product).

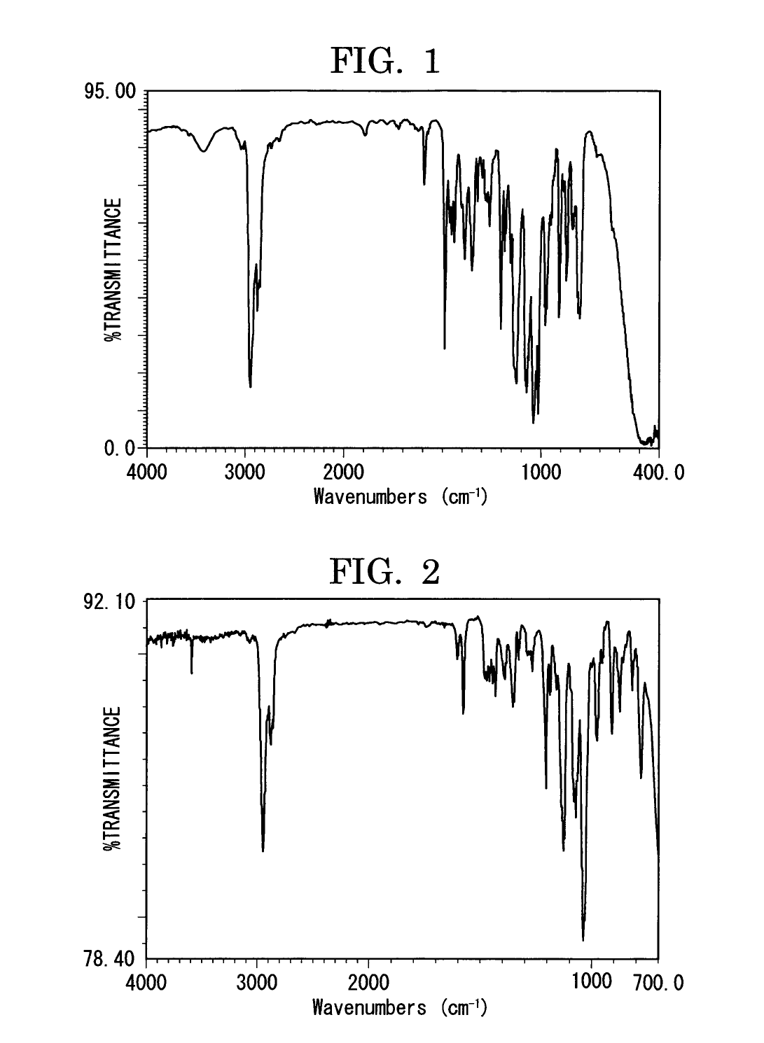

FIG. 1 shows an infrared absorption spectrum (KBr tablet method) of the compound obtained in Synthesis Example 1.

### Synthesis Example 2

### Synthesis of Halogen Intermediate

The reaction formula of Synthesis Example 2 is given below.

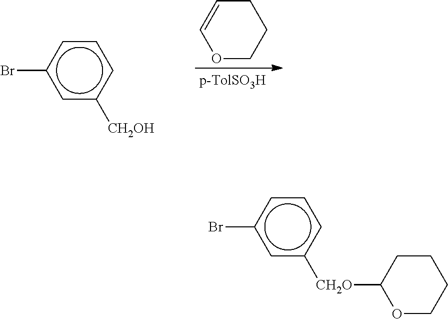

A four-neck flask was charged with 3-bromobenzyl alcohol (25.21 g), 3,4-dihydro-2H-pyran (22.50 g) and tetrahydrofuran (50 mL). The mixture was stirred at 5° C., and p-toluenesulfonic acid (0.259 g) was added to the four-neck flask. The resultant mixture was stirred at room temperature for 1 hour, and then extracted with ethyl acetate, dehydrated with magnesium sulfate, and adsorbed onto active clay and silica gel. The mixture was filtrated, washed and concentrated to obtain a compound of interest (yield: 36.84 g, a colorless oily product).

FIG. 2 shows an infrared absorption spectrum (KBr tablet method) of the compound obtained in Synthesis Example 2.

### Synthesis Example 3

### Synthesis of Halogen Intermediate

The reaction formula of Synthesis Example 3 is given below.

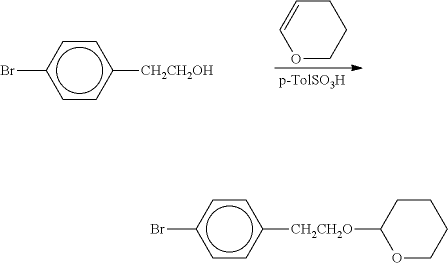

A four-neck flask was charged with 2-(4-bromobenzyl)ethylalcohol (25.05 g), 3,4-dihydro-2H-pyran (20.95 g) and tetrahydrofuran (50 mL). The mixture was stirred at 5° C., and p-toluenesulfonic acid (0.215 g) was added to the four-neck flask. The resultant mixture was stirred at room temperature for 3 hours, and then extracted with ethyl acetate, dehydrated with magnesium sulfate, and adsorbed onto active clay and silica gel. The mixture was filtrated, washed and concentrated to obtain a compound of interest (yield: 35.40 g, a colorless oily product).

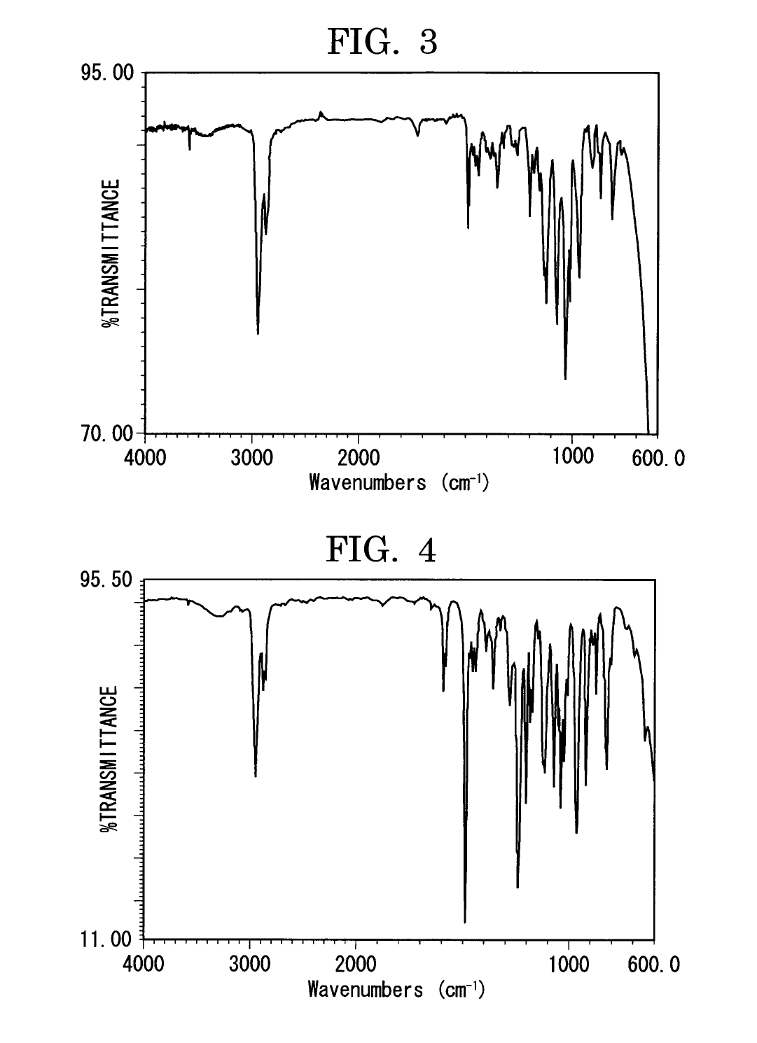

FIG. 3 shows an infrared absorption spectrum (KBr tablet method) of the compound obtained in Synthesis Example 3.

### Synthesis Example 4

### Synthesis of Halogen Intermediate

The reaction formula of Synthesis Example 4 is given below.

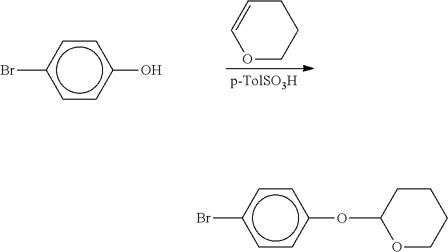

A four-neck flask was charged with 4-bromophenol (17.3 g), 3,4-dihydro-2H-pyran (16.83 g) and tetrahydrofuran (100 mL). The mixture was stirred at 5° C., and p-toluenesulfonic acid (0.172 g) was added to the four-neck flask. The resultant mixture was stirred at room temperature for 2 hours, and then extracted with ethyl acetate, dehydrated with magnesium sulfate, and adsorbed onto active clay and silica gel. The mixture was filtrated, washed and concentrated to obtain a compound of interest (yield: 27.30 g, a colorless oily product).

FIG. 4 shows an infrared absorption spectrum (KBr tablet method) of the compound obtained in Synthesis Example 4.

### Synthesis Example 5

### Synthesis of Compound No. 4

The reaction formula of Synthesis Example 5 is given below.

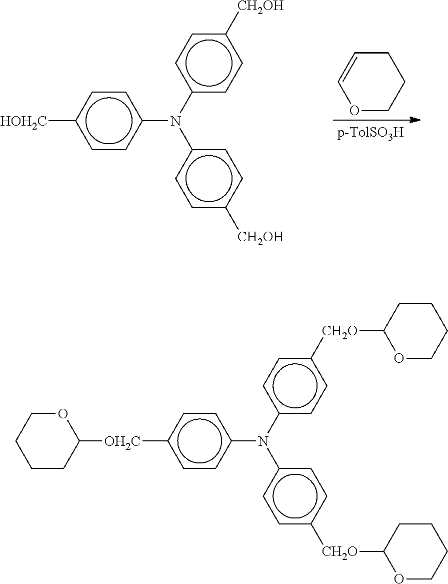

A four-neck flask was charged with an intermediate methylol compound (3.4 g), 3,4-dihydro-2H-pyran (4.65 g) and tetrahydrofuran (100 mL). The mixture was stirred at 5° C., and p-toluenesulfonic acid (58 mg) was added to the four-neck flask. The resultant mixture was stirred at room temperature for 5 hours, and then extracted with ethyl acetate, dehydrated with magnesium sulfate, and adsorbed onto active clay and silica gel. The mixture was filtrated, washed and concentrated to obtain a yellow oily product. The thus-obtained yellow oily product was purified with a silica gel column ((toluene/ethyl acetate=10/1 (by volume)) to thereby isolate a compound of interest (yield: 2.7 g, a colorless oily product).

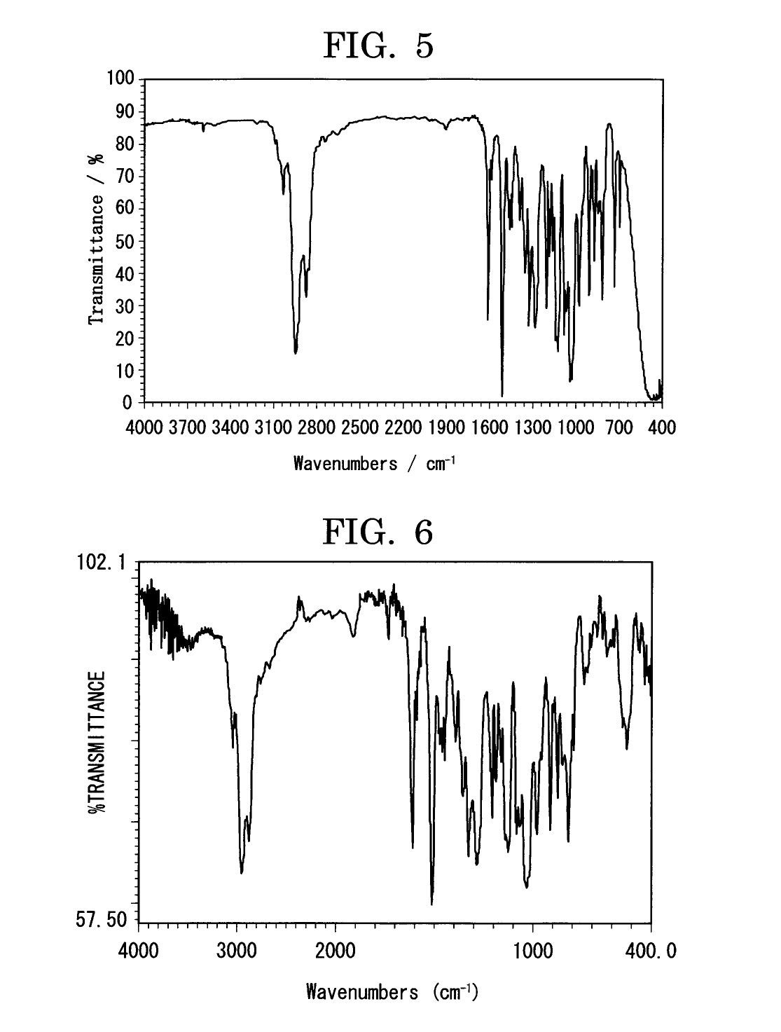

FIG. 5 shows an infrared absorption spectrum (KBr tablet method) of the compound obtained in Synthesis Example 5.

### Synthesis Example 6

### Synthesis of Compound No. 8

The reaction formula of Synthesis Example 6 is given below.

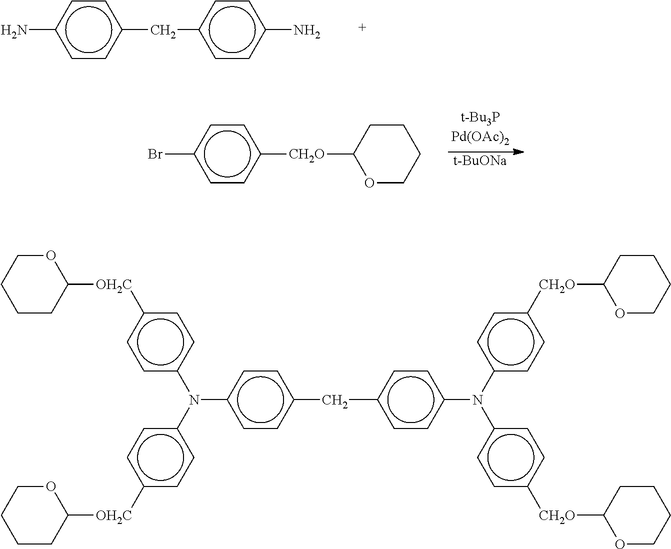

A four-neck flask was charged with 4,4′-diaminodiphenylmethane (2.99 g), the compound obtained in Synthesis Example 1 (17.896 g), palladium acetate (0.336 g), sodium tert-butoxide (13.83 g) and o-xylene (100 mL). The mixture was stirred at room temperature in an argon atmosphere. Tri-tert-butylphosphine (1.214 g) was added dropwise to the four-neck flask. The resultant mixture was stirred at 80° C. for 1 hour and then stirred under reflux for 1 hour. The mixture was diluted with toluene, and magnesium sulfate, active clay and silica gel were added to the diluted mixture, followed by stirring. The resultant mixture was filtrated, washed and concentrated to obtain a yellow oily product. The thus-obtained yellow oily product was purified with a silica gel column (toluene/ethyl acetate=20/1 (by volume)) to thereby isolate a compound of interest (yield: 5.7 g, a pale yellow amorphous product).

FIG. 6 shows an infrared absorption spectrum (KBr tablet method) of the compound obtained in Synthesis Example 6.

### Synthesis Example 7

### Synthesis of Compound No. 15

The reaction formula of Synthesis Example 7 is given below.

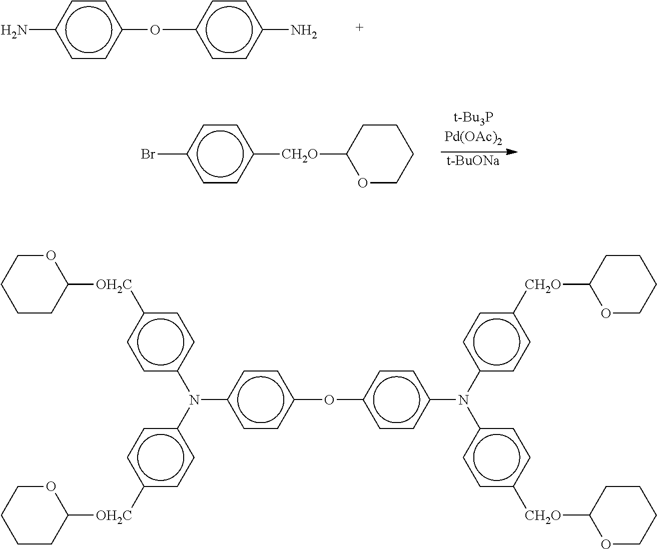

A four-neck flask was charged with 4,4′-diaminodiphenyl ether (3.0 g), the compound obtained in Synthesis Example 1 (17.896 g), palladium acetate (0.336 g), sodium tert-butoxide (13.83 g) and o-xylene (100 mL). The mixture was stirred at room temperature in an argon atmosphere. Tri-tert-butylphosphine (1.214 g) was added dropwise to the four-neck flask. The resultant mixture was stirred at 80° C. for 1 hour and then stirred under reflux for 1 hour. The mixture was diluted with toluene, and magnesium sulfate, active clay and silica gel were added to the diluted mixture, followed by stirring. The resultant mixture was filtrated, washed and concentrated to obtain a yellow oily product. The thus-obtained yellow oily product was purified with a silica gel column (toluene/ethyl acetate=10/1 (by volume)) to thereby isolate a compound of interest (yield: 5.7 g, a pale yellow oily product).

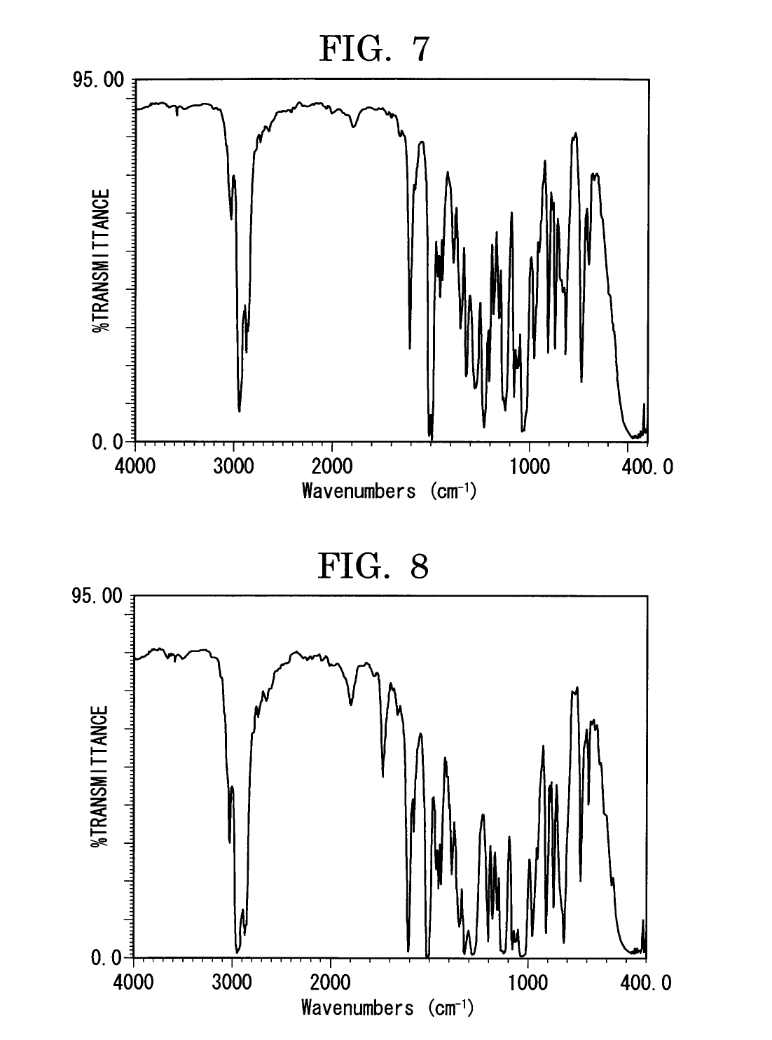

FIG. 7 shows an infrared absorption spectrum (KBr tablet method) of the compound obtained in Synthesis Example 7.

### Synthesis Example 8

### Synthesis of Compound No. 19

The reaction formula of Synthesis Example 8 is given below.

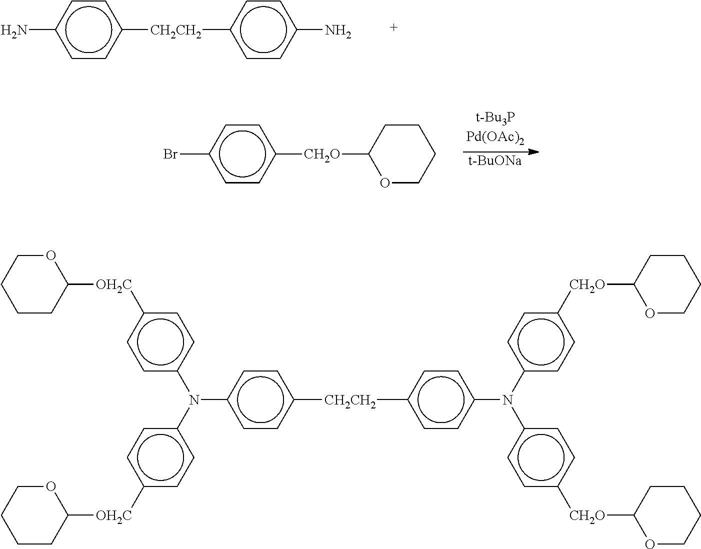

A four-neck flask was charged with 4,4′-ethylenendianiline (3.18 g), the compound obtained in Synthesis Example 1 (17.896 g), palladium acetate (0.336 g), sodium tert-butoxide (13.83 g) and o-xylene (100 mL). The mixture was stirred at room temperature in an argon atmosphere. Tri-tert-butylphosphine (1.214 g) was added dropwise to the four-neck flask. The resultant mixture was stirred at 80° C. for 1 hour and then stirred under reflux for 1 hour. The mixture was diluted with toluene, and magnesium sulfate, active clay and silica gel were added to the diluted mixture, followed by stirring. The resultant mixture was filtrated, washed and concentrated to obtain a yellow oily product. The thus-obtained yellow oily product was purified with a silica gel column (toluene/ethyl acetate=20/1 (by volume)) to thereby isolate a compound of interest (yield: 5.7 g, a pale yellow oily product).

FIG. 8 shows an infrared absorption spectrum (KBr tablet method) of the compound obtained in Synthesis Example 8.

### Synthesis Example 9

### Synthesis of Compound No. 23

The reaction formula of Synthesis Example 9 is given below.

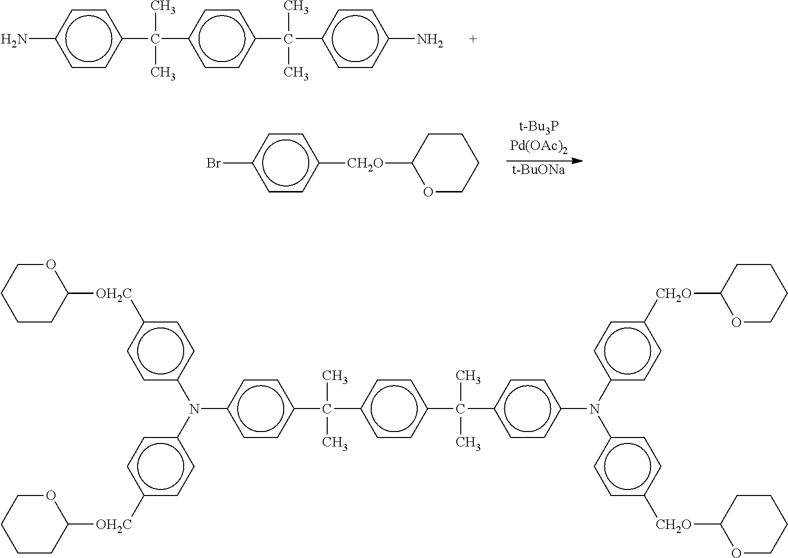

A four-neck flask was charged with α,α′-bis(4-aminophenyl)-1,4-diisopropylbenzene (10.335 g), the compound obtained in Synthesis Example 1 (39.05 g), palladium acetate (0.673 g), sodium tert-butoxide (27.677 g) and o-xylene (200 mL). The mixture was stirred at room temperature in an argon atmosphere.

Tri-tert-butylphosphine (2.43 g) was added dropwise to the four-neck flask. The resultant mixture was stirred at 80° C. for 1 hour and then stirred under reflux for 2 hours. The mixture was diluted with toluene, and magnesium sulfate, active clay and silica gel were added to the diluted mixture, followed by stirring. The resultant mixture was filtrated, washed and concentrated to obtain a yellow oily product. The thus-obtained yellow oily product was purified with a silica gel column (toluene/ethyl acetate=10/1 (by volume)) to thereby isolate a compound of interest (yield: 23.5 g, a pale yellow amorphous product).

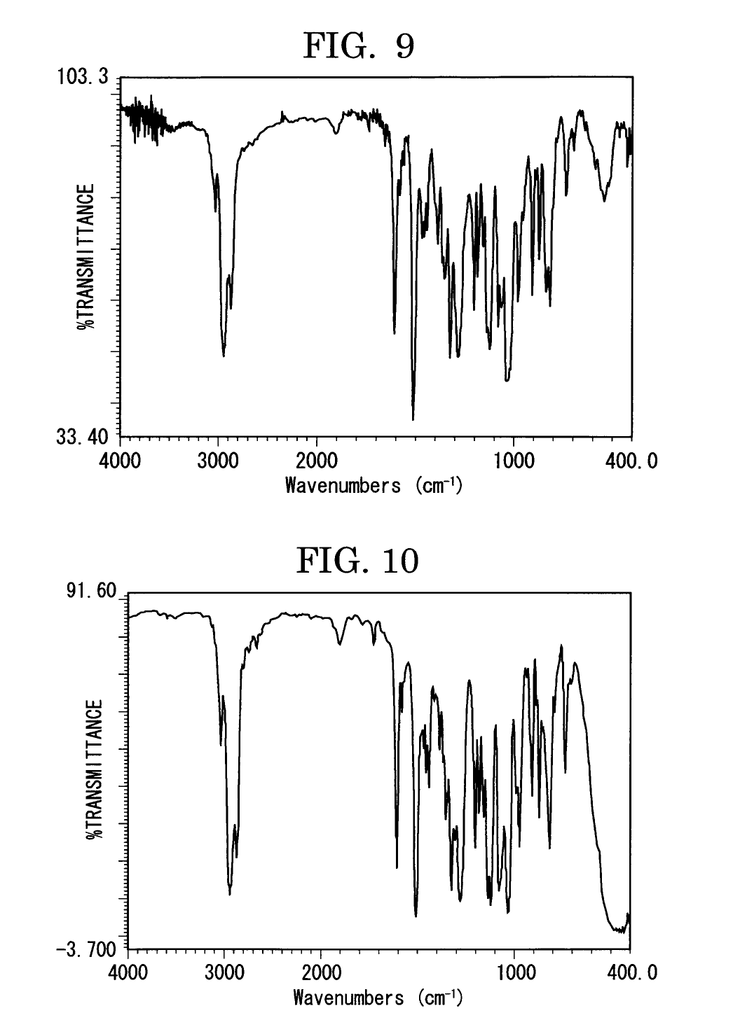

FIG. 9 shows an infrared absorption spectrum (KBr tablet method) of the compound obtained in Synthesis Example 9.

### Synthesis Example 10

### Synthesis of Comparative Compound A

The reaction formula of Synthesis Example 10 is given below.

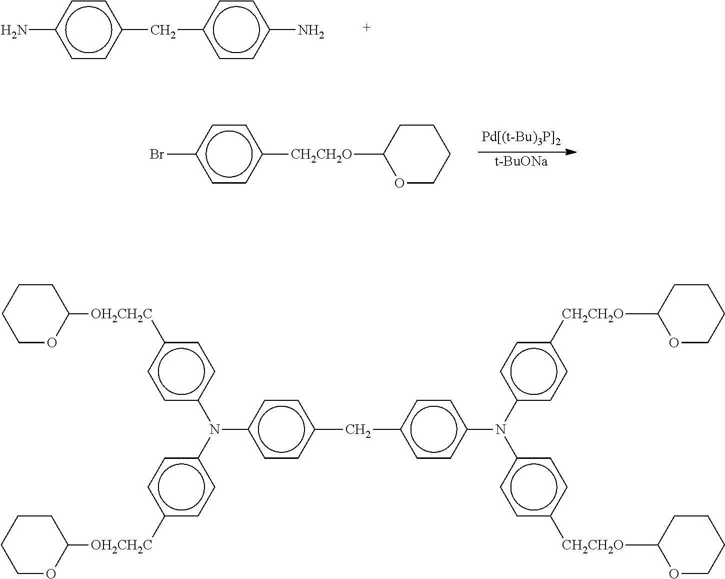

A four-neck flask was charged with 4,4′-diaminodiphenylmethane (0.991 g), the compound obtained in Synthesis Example 3 (7.41 g), sodium tert-butoxide (3.844 g), bis(tri-t-butoxyphosphine)palladium (52 mg) and o-xylene (20 mL). The mixture was stirred at room temperature in an argon atmosphere, and stirred under reflux for 1 hour. The mixture was diluted with toluene, and magnesium sulfate, active clay and silica gel were added to the diluted mixture, followed by stirring. The resultant mixture was filtrated, washed and concentrated to obtain a yellow oily product. The thus-obtained yellow oily product was purified with a silica gel column (toluene/ethyl acetate=10/1 (by volume)) to thereby isolate a compound of interest (yield: 4.12 g, a pale yellow amorphous product).

FIG. 10 shows an infrared absorption spectrum (KBr tablet method) of the compound obtained in Synthesis Example 10.

### Synthesis Example 11

### Synthesis of Comparative Compound B

The reaction formula of Synthesis Example 11 is given below.

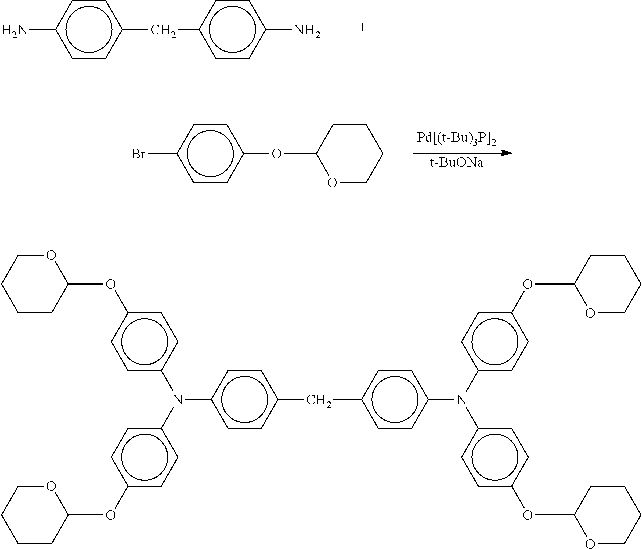

A four-neck flask was charged with 4,4′-diaminodiphenylmethane (0.991 g), the compound obtained in Synthesis Example 4 (6.603 g), sodium tert-butoxide (3.844 g), bis(tri-t-butoxyphosphine)palladium (52 mg) and o-xylene (20 mL). The mixture was stirred at room temperature in an argon atmosphere, and stirred under reflux for 1 hour. The mixture was diluted with toluene, and magnesium sulfate, active clay and silica gel were added to the diluted mixture, followed by stirring. The resultant mixture was filtrated, washed and concentrated to obtain a yellow oily product. The thus-obtained yellow oily product was purified with a silica gel column (toluene/ethyl acetate=20/1 (by volume)) to thereby isolate a compound of interest (yield: 3.52 g, a pale yellow powder).

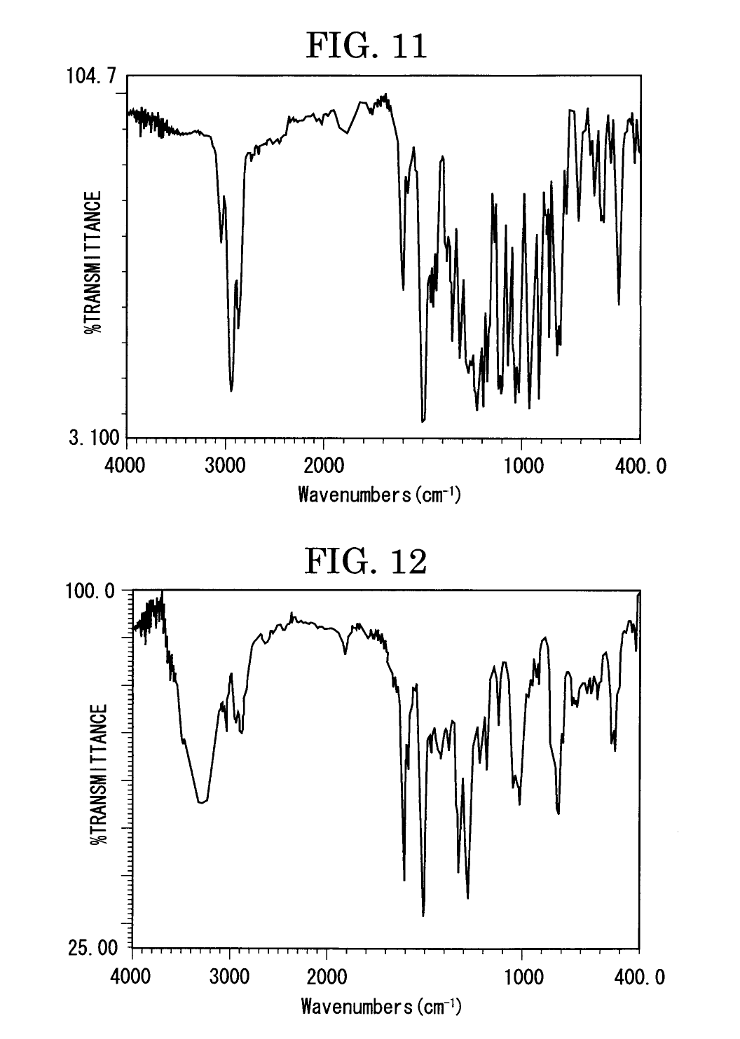

FIG. 11 shows an infrared absorption spectrum (KBr tablet method) of the compound obtained in Synthesis Example 11.

### Synthesis Example 12

### Synthesis of Comparative Compound C

The reaction formula of Synthesis Example 12 is given below.

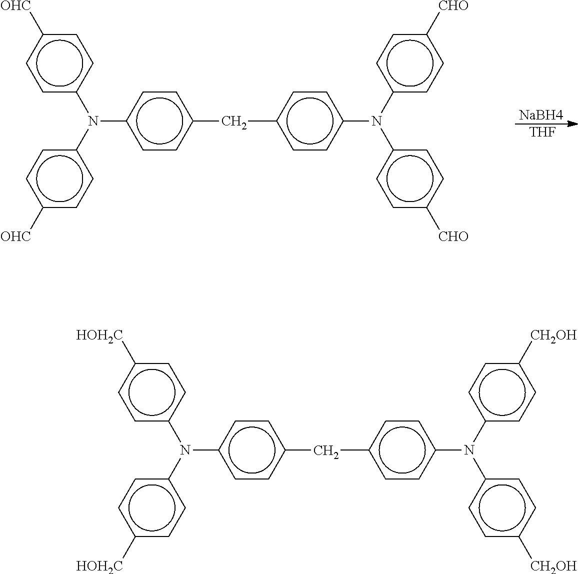

A four-neck flask was charged with an intermediate aldehyde compound (12.30 g) and ethanol (150 mL). The mixture was stirred at room temperature and sodium borohydride (3.63 g) was added thereto, followed by stirring for 4 hours. The resultant mixture was extracted with ethyl acetate, dehydrated with magnesium sulfate, and adsorbed on active clay and silica gel. The obtained product was filtrated, washed and concentrated to obtain an amorphous compound. The thus-obtained compound was dispersed in n-hexane, followed by filtrating, washing and drying, to thereby obtain a compound of interest (yield: 12.0 g, a pale yellowish-white amorphous product).

FIG. 12 shows an infrared absorption spectrum (KBr tablet method) of the compound obtained in Synthesis Example 12.

### Synthesis Example 13

### Synthesis of Comparative Compound D

The reaction formula of Synthesis Example 13 is given below.

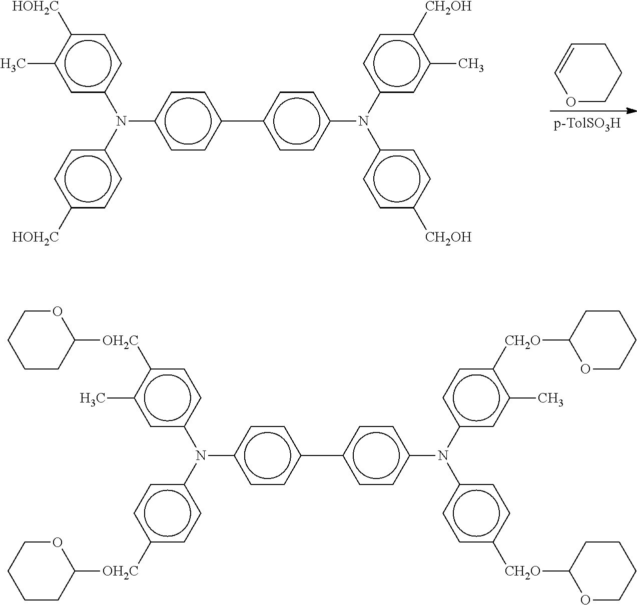

A four-neck flask was charged with an intermediate methylol compound (1.274 g), 3,4-dihydro-2H-pyran (1.346 g) and tetrahydrofuran (20 mL). The mixture was stirred at 5° C., and p-toluenesulfonic acid (14 mg) was added to the four-neck flask. The resultant mixture was stirred at room temperature for 4 hours, and then extracted with ethyl acetate, dehydrated with magnesium sulfate, and adsorbed onto active clay and silica gel. The mixture was filtrated, washed and concentrated to obtain a yellow oily product. The thus-obtained yellow oily product was purified with a silica gel column (toluene/ethyl acetate=20/1 (by volume)) to thereby isolate a compound of interest (yield: 1.48 g, a yellow oily product).

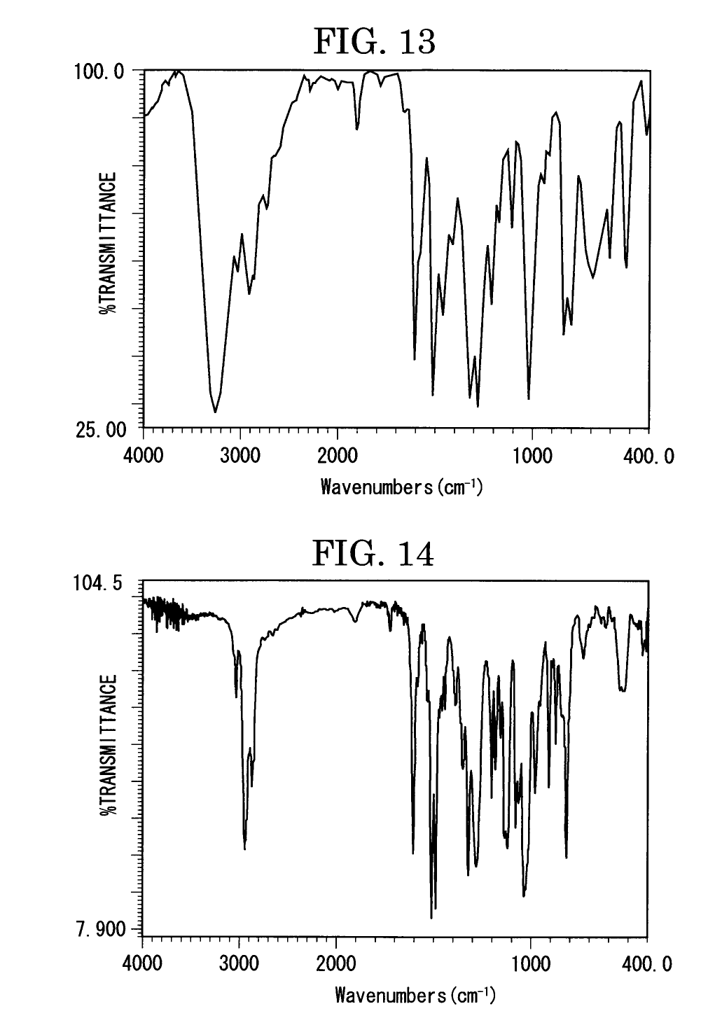

FIG. 13 shows an infrared absorption spectrum (KBr tablet method) of the compound obtained in Synthesis Example 13.

### Synthesis Example 14

### Synthesis of Comparative Compound E

The reaction formula of Synthesis Example 14 is given below.

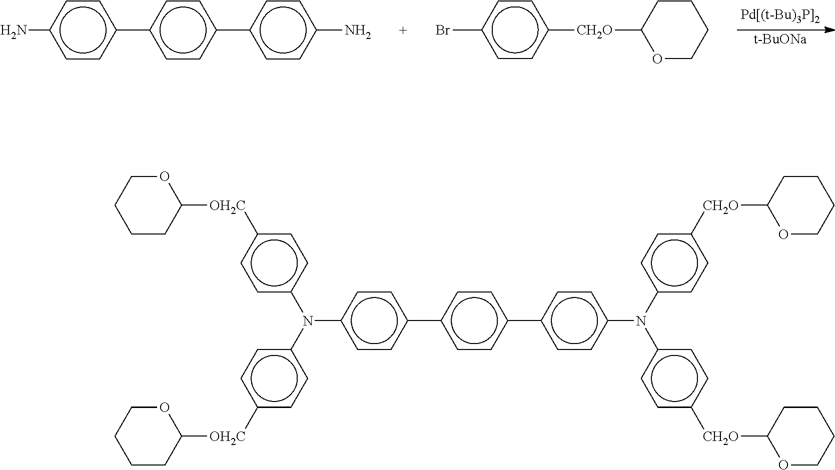

A four-neck flask was charged with 4,4′-diamino-p-terphenyl (1.30 g), the compound obtained in Synthesis Example 1 (6.508 g), sodium tert-butoxide (3.844 g), bis(tri-t-butoxyphosphine)palladium (52 mg) and o-xylene (50 mL). The mixture was stirred at room temperature in an argon atmosphere. The resultant mixture was stirred under reflux for 1 hour. The mixture was diluted with toluene, and magnesium sulfate, active clay and silica gel were added to the diluted mixture, followed by stirring. The resultant mixture was filtrated, washed and concentrated to obtain a yellow oily product. The thus-obtained yellow oily product was purified with a silica gel column (toluene/ethyl acetate=20/1 (by volume)) to thereby isolate a compound of interest (yield: 1.95 g, a pale yellow amorphous product).

FIG. 14 shows an infrared absorption spectrum (KBr tablet method) of the compound obtained in Synthesis Example 14.

### Example 1

An aluminum cylinder having a diameter of 30 mm was coated sequentially with the following under layer-coating liquid, the following charge generation layer-coating liquid and the following charge transport layer-coating liquid, followed by drying, to thereby form an under layer having a thickness of 3.5 μm, a charge generation layer having a thickness of 0.2 μm and a charge transport layer having a thickness of 25 μm, respectively.

The following crosslinked charge transport layer-coating liquid was sprayed over the formed charge transport layer, followed by drying at 150° C. for 60 min, to thereby form a crosslinked charge transport layer having a thickness of 5.0 μm. Through the above procedure, an electrophotographic photoconductor of Example 1 was produced.

### [Composition of Under Layer-Coating Liquid]

Alkyd resin

(BECKOSOL 1307-60-EL, product of DIC Corporation): 6 parts

Melamine resin

(SUPER BECKAMINE G-821-60, product of DIC Corporation): 4 parts

Titanium oxide

(CREL, product of ISHIHARA SANGYO KAISHA LTD.): 40 parts

Methyl ethyl ketone: 50 Parts

### [Composition of Charge Generation Layer-Coating Liquid]

Polyvinyl butyral (XYHL, product of UCC): 0.5 parts

Cyclohexanone: 200 parts

Methyl ethyl ketone: 80 parts

Bisazo pigment having the following structural formula: 2.4 parts

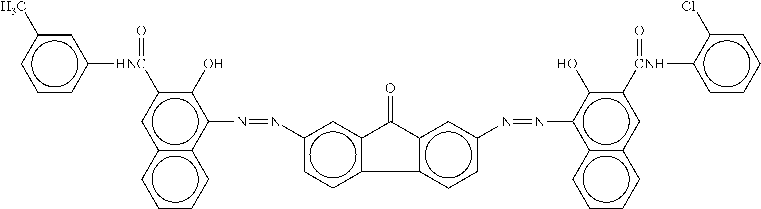

### [Composition of Charge Transport Layer-Coating Liquid]

Bisphenol Z polycarbonate (Panlite TS-2050, product of TEIJIN CHEMICALS LTD.): 10 parts

Tetrahydrofuran: 100 parts

1% by mass tetrahydrofuran solution of silicone oil (KF50-100CS, product of Shin-Etsu Chemical Co., Ltd.): 0.2 parts

Low-molecular-weight charge transport material having the following structural formula: 5 parts

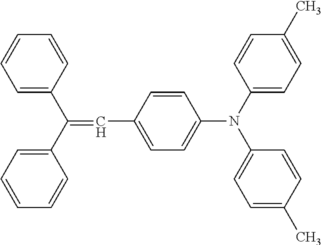 [SMILES: Cc1ccc(N(c2ccc(C)cc2)c2ccc(C=C(c3ccccc3)c3ccccc3)cc2)cc1]

### [Composition of Crosslinked Charge Transport Layer-Coating Liquid]

Compound containing charge transporting compound and three [(tetrahydro-2H-pyran-2-yl)oxy]methyl groups on the aromatic rings thereof (compound No. 4): 10 parts

Acid catalyst (p-toluenesulfonic acid monohydrate): 0.01 parts

Tetrahydrofuran (special grade): 90 parts

### Example 2

The procedure of Example 1 was repeated, except that compound No. 4 in the composition of the crosslinked charge transport layer-coating liquid was changed to compound No. 8, to thereby produce an electrophotographic photoconductor.

### Example 3

The procedure of Example 1 was repeated, except that compound No. 4 in the composition of the crosslinked charge transport layer-coating liquid was changed to compound No. 15, to thereby produce an electrophotographic photoconductor.

### Example 4

The procedure of Example 1 was repeated, except that compound No. 4 in the composition of the crosslinked charge transport layer-coating liquid was changed to compound No. 19, to thereby produce an electrophotographic photoconductor.

### Example 5

The procedure of Example 1 was repeated, except that compound No. 4 in the composition of the crosslinked charge transport layer-coating liquid was changed to compound No. 23, to thereby produce an electrophotographic photoconductor.

### Comparative Example 1

The procedure of Example 1 was repeated, except that compound No. 4 in the composition of the crosslinked charge transport layer-coating liquid was changed to compound A, to thereby produce an electrophotographic photoconductor.

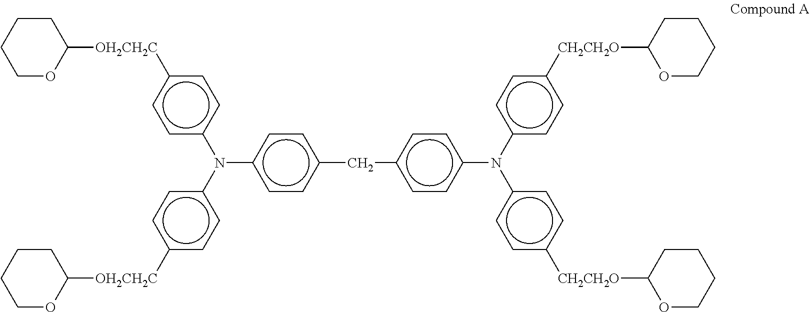

### Comparative Example 2

The procedure of Example 1 was repeated, except that compound No. 4 in the composition of the crosslinked charge transport layer-coating liquid was changed to compound B, to thereby produce an electrophotographic photoconductor.

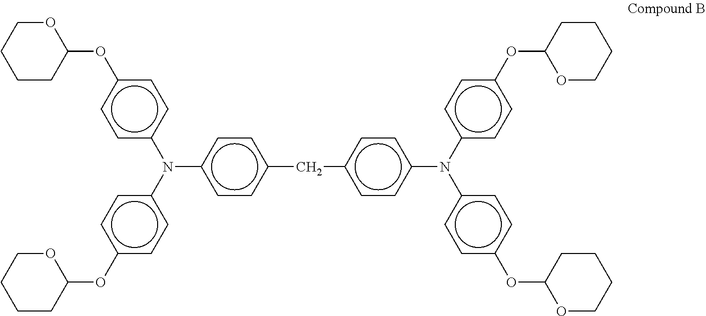

### Comparative Example 3

The procedure of Example 1 was repeated, except that compound No. 4 in the composition of the crosslinked charge transport layer-coating liquid was changed to compound C, to thereby produce an electrophotographic photoconductor.

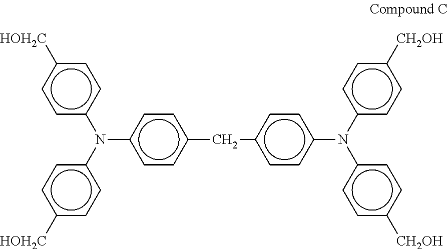

### Comparative Example 4

The procedure of Example 1 was repeated, except that compound No. 4 in the composition of the crosslinked charge transport layer-coating liquid was changed to compound D, to thereby produce an electrophotographic photoconductor.

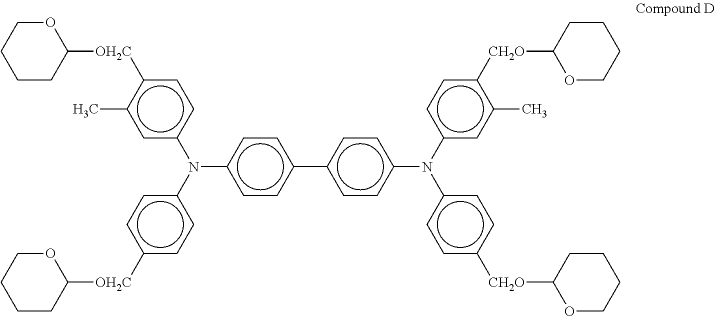

### Comparative Example 5

The procedure of Example 1 was repeated, except that compound No. 4 in the composition of the crosslinked charge transport layer-coating liquid was changed to compound E, to thereby produce an electrophotographic photoconductor.

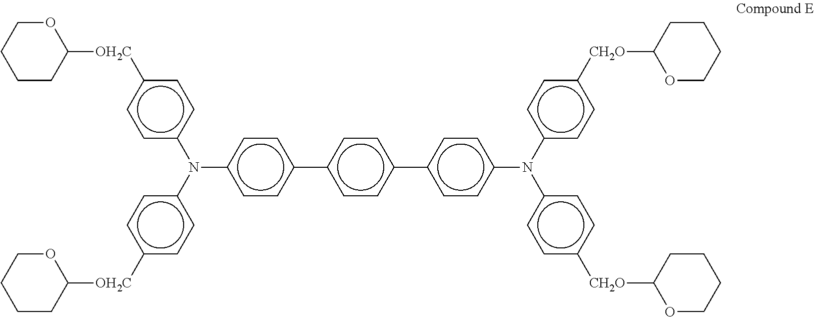

### Comparative Example 6

The procedure of Example 1 was repeated, except that compound No. 4 in the composition of the crosslinked charge transport layer-coating liquid was changed to compound F, to thereby produce an electrophotographic photoconductor.

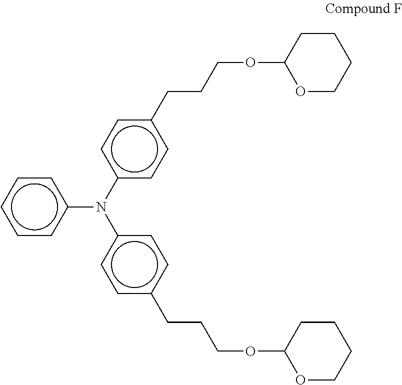

### Comparative Example 7

The procedure of Example 1 was repeated, except that compound No. 4 in the composition of the crosslinked charge transport layer-coating liquid was changed to compound G, to thereby produce an electrophotographic photoconductor.

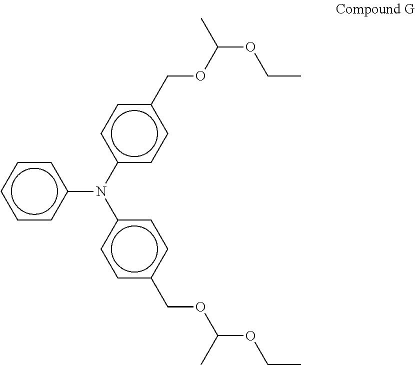

### Comparative Example 8

The procedure of Example 1 was repeated, except that the crosslinked charge transport layer-coating liquid was changed to the following crosslinked charge transport layer-coating liquid, to thereby produce an electrophotographic photoconductor.

### [Composition of Crosslinked Charge Transport Layer-Coating Liquid]

Charge transporting compound

Compound G used in Comparative Example 7: 5.5 parts

Resol-type phenol resin PL-2211 (product of Gunei Chemical Industry Co., Ltd.): 7 parts

Acid catalyst NACURE2500 (product of product of KUSUMOTO CHEMICALS, Ltd.): 0.2 parts

Isopropanol: 15 parts

Methyl ethyl ketone: 5 parts

### Comparative Example 9

The procedure of Example 1 was repeated, except that compound No. 4 in the composition of the crosslinked charge transport layer-coating liquid was changed to compound H, to thereby produce an electrophotographic photoconductor.

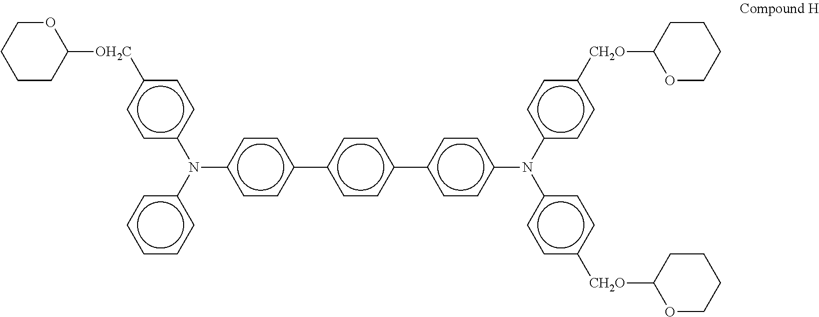

### Comparative Example 10

The procedure of Example 1 was repeated, except that no crosslinked charge transport layer was formed, to thereby produce an electrophotographic photoconductor.

### Dissolution Test and Evaluation of Surface Smoothness of Crosslinked Charge Transport Layer

The crosslinked charge transport layer was studied for crosslinking reactivity based on a dissolution test. The dissolution test was performed as follows. Specifically, the crosslinked charge transport layer-coating liquid was directly coated on an aluminum support in the same manner as in Examples 1 to 5 and Comparative Examples 1 to 9, followed by drying with heating, to thereby form a film (cured product). The surface of the cured product was rubbed with a swab soaked in tetrahydrofuran and then observed. The evaluation was performed according to the following criteria.

A: There were no changes or traces in the portions rubbed with the swab.
B: The film was left in the portions rubbed with the swab but swollen to form traces.
C: The film was dissolved.

The surface smoothness of the crosslinked charge transport layer was measured with a surface texture and contour measuring instrument (product of TOKYO SEIMITSU CO., LTD., SURFCOM 1400D) to thereby obtain a value of ten-point height of irregularities (Rz) according to JIS-1982. The evaluation was performed according to the following criteria.

Good: The value was 1 μm or lower.
Bad: The value was higher than 1 μm.

The results are shown in Table 2.

TABLE 2

| | Compound | Dissolution test | Surface smoothness |
|---|---|---|---|
| Ex. 1 | 4 | A | Good |
| Ex. 2 | 8 | | Good |
| Ex. 3 | 15 | | Good |
| Ex. 4 | 19 | | Good |
| Ex. 5 | 23 | | Good |
| Comp. Ex. 1 | A | C | Not measurable |
| Comp. Ex. 2 | B | B | Bad |
| Comp. Ex. 3 | C | A | Good |
| Comp. Ex. 4 | D | | Good |
| Comp. Ex. 5 | E | | Good |
| Comp. Ex. 6 | F | C | Not measurable |
| Comp. Ex. 7 | G | | Not measurable |
| Comp. Ex. 8 | | A | Good |
| Comp. Ex. 9 | H | | |

The cured films (three-dimensionally crosslinked films) of Examples 1 to 5, which had been formed from the compound of the present invention containing a charge transporting compound and three or more [(tetrahydro-2H-pyran-2-yl)oxy]methyl groups on the aromatic rings thereof, were found to exhibit good reactivity; i.e., be insoluble to the solvent.

However, the film of Comparative Example 1, which had been formed from the compound containing a charge transporting compound and four [(tetrahydro-2H-pyran-2-yl)oxy]ethyl groups bound to the aromatic rings thereof, was found to exhibit no reactivity; i.e., dissolve in the solvent. In addition, the film of Comparative Example 2, which had been formed from the compound containing a charge transporting compound and four [(tetrahydro-2H-pyran-2-yl)oxy] groups bound to the aromatic rings thereof, was found to exhibit reactivity but not to be a sufficiently crosslinked film.

The cured film of Comparative Example 3, which had been formed from the compound containing a charge transporting compound and four methylol groups bound to the aromatic rings thereof, were found to be an insoluble film similar to the cured films of Examples 1 to 5.

The cured films of Comparative Examples 4 and 5, which had been formed from the compound containing a charge transporting compound and three or more [(tetrahydro-2H-pyran-2-yl)oxy]methyl groups bound to the aromatic rings thereof, were found to be an isoluble film similar to the cured films of Examples 1 to 5. However, as described below, the cured films of Comparative Examples 4 and 5 were found to have an ionization potential of lower than 5.4.

The films of Comparative Examples 6 and 7 were found to dissolve similar to the film of Comparative Example 1. The cured films of Comparative Examples 8 and 9 were found to be insoluble to the solvent.

The films of Comparative Examples 1, 6 and 7, which dissolved in the solvent in the dissolution test, were found to have liquid surfaces and thus, could not be evaluated for surface smoothness. Also, the film of Comparative Example 2, which was swollen in the dissolution test, was found to have bad surface smoothness. The films of Examples 1 to 5 and Comparative Examples 3 to 5, 8 and 9, which were insoluble to the solvent in the dissolution test, were found to have good surface smoothness.

### Measurement of Ionization Potential

Each of the electrophotographic photoconductors of Examples 1 to 5 and Comparative Examples 3, 4, 5, 8 and 9 was measured for ionization potential (Ip) as follows.

First, the surface of the electrophotographic photoconductor was cut with a cutter knife so as to have a size of about 1 cm×1 cm, and the cut section was peeled off. The thus-obtained section of the uppermost surface of the electrophotographic photoconductor was subjected to photoelectron yield spectroscopy or PYS using an apparatus for photoelectron spectroscopy in air (AC-2: product of RIKEN KEIKI Co., Ltd.). Then, the ionization potential was calculated through plotting based on ⅓ power of photoelectron yield as follows. Specifically, the number of photoelectrons was plotted against incident light energy at a light irradiation dose of 50 nW to obtain a spectrum. Then, the ionization potential was calculated by extrapolating a straight line segment in the rising of the spectrum.

The measurement spectrum in Example 2 is shown in FIG. 23 and the measurement spectrum in Comparative Example 4 is shown in FIG. 24. Also, all the results calculated in the same manner as described above are shown in Table 3.

TABLE 3

| | Compound | Ip (eV) |
|---|---|---|
| Ex. 1 | 4 | 5.4 |
| Ex. 2 | 8 | 5.4 |
| Ex. 3 | 15 | 5.5 |
| Ex. 4 | 19 | 5.5 |
| Ex. 5 | 23 | 5.6 |
| Comp. Ex. 3 | C | 5.4 |
| Comp. Ex. 4 | D | 5.3 |
| Comp. Ex. 5 | E | 5.3 |
| Comp. Ex. 8 | G | 5.5 |
| Comp. Ex. 9 | H | 5.3 |

### Evaluation of Image Output

Each of the electrophotographic photoconductors produced in Examples 1 to 5 and Comparative Examples 3 to 5, 8, 9 and 10 was evaluated for mechanical strength, electrical characteristics and gas resistance. Each electrophotographic photoconductor was mounted to the process cartridge of a digital full-color complex machine IMAGIONeo455 (product of Ricoh, Company Ltd.). The process cartridge was caused to continuously print out 100,000 sheets in total with the unexposed-area potential being set to 700 (−V).

Also, it was caused to form a 2×2 image chart of 600 dpi (1 inch=2.54 cm), which was measured with an image densitometer (X-Rite939, product of SDG Co.) to evaluate the image quality.

The mechanical strength was evaluated based on abrasion degree; i.e., the difference in film thickness of the photoconductor between the initial state and the state after the 100,000 sheet-printing.

The electrical characteristics were evaluated based on the exposed-area potential at about 0.4 μJ/cm² of the quantity of image exposing light at the initial state and after the 100,000 sheet-printing and on the unexposed-area potential after the 100,000 sheet-printing.

The gas resistance was evaluated as follows. Specifically, using a NOx exposure testing apparatus (product of Dylec, Co.), each electrophotographic photoconductor was exposed at ambient temperature and ambient humidity for 4 days to an atmosphere of NO concentration: 40 ppm/NO₂ concentration: 10 ppm. Then, the image quality of images produced thereby after the NOx exposure was evaluated according to the following criteria.

### Criteria for Evaluation of Image Quality

A: The density was higher than 0.3.
B: The density was higher than 0.2 but 0.3 or lower.
C: The density was higher than 0.1 but 0.2 or lower.
D: The density was 0 or higher but 0.1 or lower.

It is clear that the electrophotographic photoconductors in which dissolution or swelling was observed in the above-described dissolution test did not have a firm three-dimensional crosslinked structure. Thus, it is difficult for these electrophotographic photoconductors to exhibit satisfactory abrasion resistance for a long period of time and thus, no evaluation was made for them. The results are shown in Tables 4-1 and 4-2.

TABLE 4-1

| | Mechanical | Electrical characteristics | | |
|---|---|---|---|---|
| | strength | Exposed | | Unexposed |
| | Abrasion | potential (−V) | | potential (−V) |
| | degree | | After 100,000- | After 100,000- |
| | (μm) | Initial | sheet printing | sheet printing |
| Ex. 1 | 0.2 | 57 | 63 | 690 |
| Ex. 2 | 0.2 | 55 | 58 | 695 |
| Ex. 3 | 0.3 | 65 | 75 | 692 |
| Ex. 4 | 0.3 | 54 | 60 | 693 |
| Ex. 5 | 0.3 | 59 | 65 | 691 |
| Comp. | 0.3 | 57 | 89 | 624 |
| Ex. 3 | | | | |
| Comp. | 0.4 | 46 | 58 | 613 |
| Ex. 4 | | | | |
| Comp. | 0.5 | 42 | 48 | 609 |
| Ex. 5 | | | | |
| Comp. | 1.6 | 120 | 145 | 665 |
| Ex. 8 | | | | |
| Comp. | 0.9 | 45 | 52 | 615 |
| Ex. 9 | | | | |
| Comp. | 11.5 | 35 | 28 | 521 |
| Ex. 10 | | | | |

TABLE 4-2

| | Image quality | | |
|---|---|---|---|
| | Image density | | |
| | | After 100,000- | After Nox |
| | Initial | sheet printing | exposure |
| Ex. 1 | A | A | A |
| Ex. 2 | A | A | A |
| Ex. 3 | A | A | A |
| Ex. 4 | A | A | A |
| Ex. 5 | A | A | A |
| Comp. | B | C | D |
| Ex. 3 | | | |
| Comp. | B | C | C |
| Ex. 4 | | | |
| Comp. | B | C | C |
| Ex. 5 | | | |
| Comp. | A | B | C |
| Ex. 8 | | | |
| Comp. | B | C | C |
| Ex. 9 | | | |
| Comp. | A | A | |
| Ex. 10 | | Background smear | A |
| | | observed | |

From the results shown in Tables 4-1 and 4-2, the electrophotographic photoconductors of Examples 1 to 5, each containing a three-dimensionally crosslinked film formed from the compound containing a charge transporting compound and three or more [(tetrahydro-2H-pyran-2-yl)oxy]methyl groups bound to the aromatic rings thereof and having an ionization potential of 5.4 or higher, were found to have high abrasion resistance, excellent electrical characteristics with less unexposed-area potential, excellent gas resistance, and long service life.

As compared with the electrophotographic photoconductor of Comparative Example 10 containing no crosslinked charge transport layer, the other electrophotographic photoconductors were found to be remarkably high in abrasion resistance. Even when time passes, they involve no abnormal image formation with black spots due to charge leakage caused through thinning of the charge transport layer as a result of abrasion; can maintain high-quality image formation. As compared with the electrophotographic photoconductors of Comparative Examples 2 and 8, containing the conventional, thermally-crosslinked film such as the crosslinked film formed from the charge transporting compound with methylol groups or the conventional crosslinked film formed from a phenol resin, other electrophotographic photoconductors are excellent in charging stability and gas resistance; can maintain high-quality image formation.

The electrophotographic photoconductors of Comparative Examples 4 and 5, each having, as the uppermost surface layer, a three-dimensionally crosslinked surface layer formed from the compound containing a charge transporting compound and four [(tetrahydro-2H-pyran-2-yl)oxy]methyl groups bound to the aromatic rings thereof and having an ionization potential of lower than 5.4, are high in abrasion resistance and low in exposed-area potential. Although these electrophotographic photoconductors are excellent in charge transporting property, they are greatly decreased in unexposed-area potential and are also low in gas resistance.

The electrophotographic photoconductor of Comparative Example 9, having, as the uppermost surface layer, a three-dimensionally crosslinked surface layer formed from the compound containing a charge transporting compound and four [(tetrahydro-2H-pyran-2-yl)oxy]methyl groups bound to the aromatic rings thereof and having an ionization potential of lower than 5.4, was found to exhibit comparable characteristic to those in Comparative Examples 4 and 5.

The electrophotographic photoconductor of Example 1, using the charge transporting compound represented by General Formulas (1) and (3), and the electrophotographic photoconductors of Examples 2 to 5, using the charge transporting compound represented by General Formula (2) and (4), are excellent in various characteristics in favorable balance.

As described above, the image forming method, the image forming apparatus, and the process cartridge for image forming apparatus each using the electrophotographic photoconductor of the present invention having the three-dimensionally crosslinked film formed of the compound containing a charge transporting compound and three or more [(tetrahydro-2H-pyran-2-yl)oxy]methyl groups bound to the aromatic rings thereof and having an ionization potential of 5.4 or higher can continue to output high-quality images for a long period of time, and even under the changing environment, can continue to output high-quality images stably.

### REFERENCE SIGNS LIST

1: Conductive substrate
4: Under layer
2: Charge generation layer
3: Charge transport layer
5: Crosslinked charge transport layer
6: Photoconductive layer
7: Protective layer
10, 10Y, 10M, 10C, 10K: Photoconductor
11, 11Y, 11M, 11C, 11K: Charging member
12, 12Y, 12M, 12C, 12K: Laser light
13, 13Y, 13M, 13C, 13K: Developing member
14: Conveyance roller
15: Image receiving paper sheet
16, 16Y, 16M, 16C, 16K: Transfer member
17, 17Y, 17M, 17C, 17K: Cleaning member
18: Charge-eliminating member
20Y, 20M, 20C, 20K: Image forming unit
21: Paper feeding roller
22: Registration roller
23: Transfer member (secondary transfer member)
24: Fixing member

1. An electrophotographic photoconductor, comprising:
a conductive substrate; and
at least a photoconductive layer on the conductive substrate,
wherein
an uppermost surface layer of the photoconductive layer comprises a three-dimensionally crosslinked film formed through polymerization of compounds (A) each comprising: a charge transporting compound comprising one or more aromatic rings, and three or more [(tetrahydro-2H-pyran-2-yl)oxy]methyl groups bound to the aromatic rings of the charge transporting compound,
the polymerization starts after some of the [(tetrahydro-2H-pyran-2-yl)oxy]methyl groups have been partially cleaved and eliminated, and
the three-dimensionally crosslinked film has an ionization potential of 5.4 or higher.

2. The electrophotographic photoconductor according to claim 1, wherein the three-dimensionally crosslinked film is insoluble in tetrahydrofuran.

3. The electrophotographic photoconductor according to claim 1, wherein compound (A) is a compound of Formula (1): 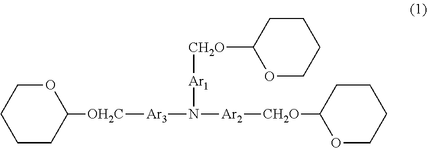
wherein Ar₁, Ar₂ and Ar₃ each is independently a divalent group of a C6-C12 aromatic hydrocarbon optionally comprising an alkyl substituent.

4. The electrophotographic photoconductor according to claim 1, wherein compound (A) is a compound of Formula (2): 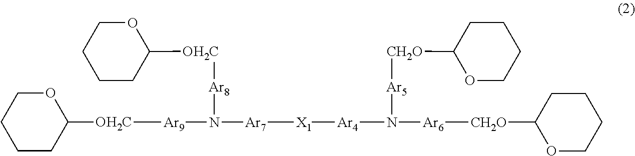
wherein
X₁ is a C1-C4 alkylene group, a C2-C6 alkylidene group, a divalent group of two C2-C6 alkylidene groups bonded together via a phenylene group, or an oxygen atom, and
Ar₄, Ar₅, Ar₆, Ar₇, Ar₈ and Ar₉ each is independently a divalent group of a C6-C12 aromatic hydrocarbon optionally comprising an alkyl substituent.

5. The electrophotographic photoconductor according to claim 3, wherein the compound (A) is a compound of Formula (3): 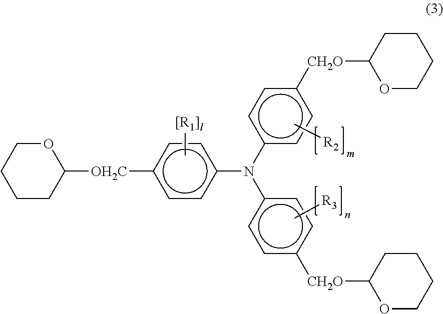
wherein
R₁, R₂ and R₃ each is independently a hydrogen atom, a methyl group or an ethyl group; and
l, n and m each is independently an integer of from 1 to 4.

6. The electrophotographic photoconductor according to claim 4, wherein the compound (A) is a compound of Formula (4): 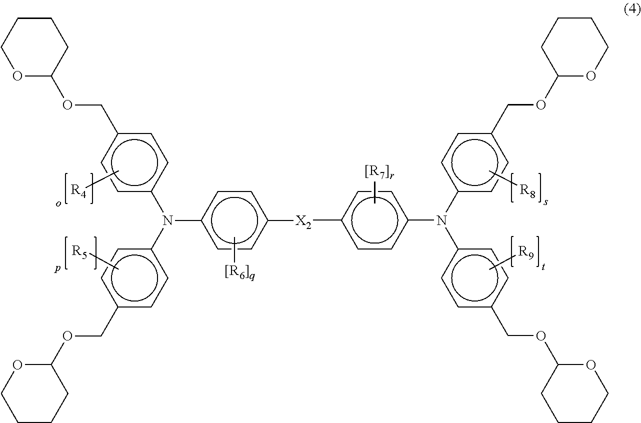
wherein
X₂ is —CH₂—, —CH₂CH₂—, —C(CH₃)₂-Ph-C(CH₃)₂—, —C(CH₂)₅— or —O—;
R₄, R₅, R₆, R₇, R₈ and R₉ each is independently a hydrogen atom, a methyl group or an ethyl group; and
o, p, q, r, s and t each is independently an integer of from 1 to 4.

7. The electrophotographic photoconductor according to claim 1, wherein
the photoconductive layer comprises a charge generation layer, a charge transport layer and a crosslinked charge transport layer disposed in this order on the conductive substrate, and
the crosslinked charge transport layer is the three-dimensionally crosslinked film.

8. An image forming method comprising:
charging a surface of the electrophotographic photoconductor according to claim 1 to obtain a charged surface of the electrophotographic photoconductor;
exposing the charged surface of the electrophotographic photoconductor to light to form a latent electrostatic image;
developing the latent electrostatic image with a toner to form a visible image;
transferring the visible image onto a recording medium; and
fixing the transferred visible image on the recording medium.

9. The image forming method according to claim 8, wherein the latent electrostatic image is digitally written on the electrophotographic photoconductor in said exposing.

10. An image forming apparatus comprising:
the electrophotographic photoconductor according to claim 1;
a charging unit configured to charge a surface of the electrophotographic photoconductor to obtain a charged surface of the electrophotographic photoconductor;
an exposing unit configured to expose the charged surface of the electrophotographic photoconductor to light to form a latent electrostatic image;
a developing unit configured to develop the latent electrostatic image with a toner to form a visible image;
a transfer unit configured to transfer the visible image onto a recording medium; and
a fixing unit configured to fix the transferred visible image on the recording medium.

11. The image forming apparatus according to claim 10, wherein the exposing unit digitally writes the latent electrostatic image on the electrophotographic photoconductor.

12. (canceled)

13. The image forming method according to claim 8, wherein the three-dimensionally crosslinked film is insoluble in tetrahydrofuran.

14. The image forming method according to claim 8, wherein compound (A) is a compound of Formula (1): 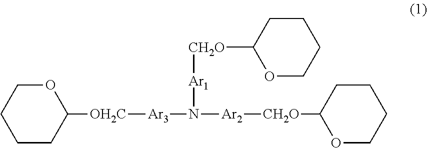
wherein Ar₁, Ar₂ and Ar₃ each is independently a divalent group of a C6-C12 aromatic hydrocarbon optionally comprising an alkyl substituent.

15. The image forming method according to claim 8, wherein compound (A) is a compound of Formula (2): 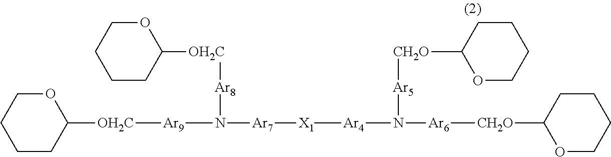
wherein
X₁ is a C1-C4 alkylene group, a C2-C6 alkylidene group, a divalent group of two C2-C6 alkylidene groups bonded together via a phenylene group, or an oxygen atom; and
Ar₄, Ar₅, Ar₆, Ar₇, Ar₈ and Ar₉ each is independently a divalent group of a C6-C12 aromatic hydrocarbon optionally comprising an alkyl substituent.

16. The image forming method according to claim 8, wherein compound (A) is a compound of Formula (3): 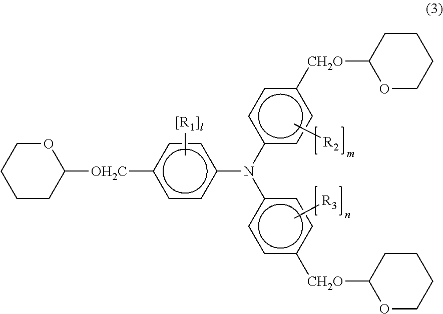
wherein
R₁, R₂ and R₃ each is independently a hydrogen atom, a methyl group or an ethyl group; and
l, n and m each is independently an integer of from 1 to 4.

17. The image forming method according to claim 8, wherein compound (A) is a compound of Formula (4): 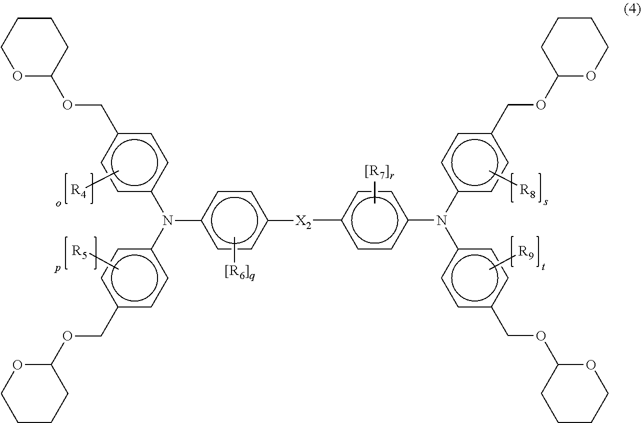
wherein
X₂ is —CH₂—, —CH₂CH₂—, —C(CH₃)₂-Ph-C(CH₃)₂—, —C(CH₂)₅— or —O—;
R₄, R₅, R₆, R₇, R₈ and R₉ each is independently a hydrogen atom, a methyl group or an ethyl group; and
o, p, q, r, s and t each is independently an integer of from 1 to 4.

18. The image forming apparatus according to claim 10, wherein the three-dimensionally crosslinked film is insoluble in tetrahydrofuran.

19. The image forming apparatus according to claim 10, wherein compound (A) is a compound of Formula (1): 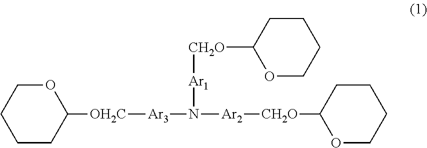
wherein Ar₁, Ar₂ and Ar₃ each is independently a divalent group of a C6-C12 aromatic hydrocarbon optionally comprising an alkyl substituent.

20. The image forming apparatus according to claim 10, wherein compound (A) is a compound of Formula (2): 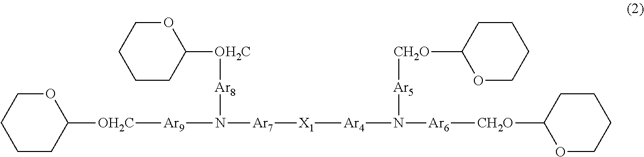
wherein
X₁ is a C1-C4 alkylene group, a C2-C6 alkylidene group, a divalent group of two C2-C6 alkylidene groups bonded together via a phenylene group, or an oxygen atom; and
Ar₄, Ar₅, Ar₆, Ar₇, Ar₈ and Ar₉ each is independently a divalent group of a C6-C12 aromatic hydrocarbon optionally comprising an alkyl substituent.

21. The image forming apparatus according to claim 10, wherein compound (A) is a compound of Formula (3): 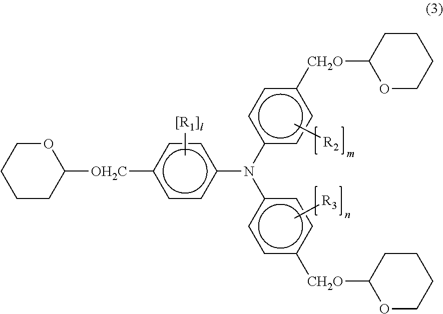
wherein
R₁, R₂ and R₃ each is independently a hydrogen atom, a methyl group or an ethyl group; and
l, n and m each is independently an integer of from 1 to 4.
